(19) United States
(12) Patent Application Publication
(10) Pub. No.: US 2024/0107606 A1
(43) Pub. Date: Mar. 28, 2024

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventors: Haoyuan DU, Dongguan (CN); Ronghui HOU, Dongguan (CN); Lei HUANG, Singapore (SG); Liuming LU, Dongguan (CN); Chaoming LUO, Dongguan (CN); Pei ZHOU, Dongguan (CN)

(73) Assignee: GUANGDONG OPPO MOBILE TELECOMMUNICATIONS CORP., LTD., Dongguan (CN)

(21) Appl. No.: 18/527,195

(22) Filed: Dec. 1, 2023

Related U.S. Application Data
(63) Continuation of application No. PCT/CN2021/098025, filed on Jun. 2, 2021.

(51) Int. Cl. H04W 76/15; H04W 74/08

(52) U.S. Cl. CPC H04W 76/15; H04W 74/08

(57) ABSTRACT

Provided in the embodiments of the present application are a wireless communication method and device. For NSTR characteristics of a mobile AP MLD, it is designed that uplink simultaneous transmission between a plurality of independent non-access-point devices is triggered in a mobile AP MLD scenario. By means of the embodiments of the present application, an uplink access restriction is relaxed, and under the condition of not affecting the transmission quality of a single-link device on a main link, the success rate of uplink simultaneous transmission between mobile AP MLDs is increased, and a transmission service having a high throughput is also provided.

### CROSS REFERENCE TO RELATED APPLICATION

The present application is a continuation application of the international patent application No. PCT/CN2021/098025, filed on Jun. 2, 2021, and contents of which are incorporated herein by its entireties.

### TECHNICAL FIELD

The present disclosure relates to the field of communication, and in particular to a wireless communication method and a wireless communication device.

### BACKGROUND

A mobile access point multilink device (mobile AP MLD) is introduced into the 802.11be standard. The mobile AP MLD may be commonly used as a Wi-Fi hotspot or a network sharing. Since the mobile AP MLD may perform non-simultaneous transmission and receiving, it is difficult to obtain multilink gain while the mobile AP MLD is in use. Therefore, how to improve multilink performance of the mobile AP MLD is an urgent problem to be solved.

### SUMMARY OF THE DISCLOSURE

The present disclosure provides a method and a device for wireless communication which triggers uplink synchronous transmission between multiple independent non-APs while the mobile AP MLD is in use, improving a success rate of uplink synchronous transmission in the mobile AP MLD and providing a transmission service having a high throughput.

In a first aspect, a wireless communication method is provided and includes:
transmitting, by an access point (AP) multilink device (MLD), a first information on a primary link to a first non-access point station (non-AP STA) in a first non-AP MLD; or transmitting, by the AP MLD, the first information on the primary link to the first non-AP STA;
synchronously transmitting, by the AP MLD, a second information on a non-primary link to a second non-AP STA in a second non-AP MLD, wherein the second information is configured to share a transmission opportunity (TXOP), which is obtained by the AP MLD on the non-primary link, to the second non-AP STA.

The first information is configured to indicate a length of an uplink physical layer protocol data unit (PPDU) transmitted on the primary link, the second information is configured to indicate a length of an uplink PPDU transmitted on the non-primary link, and the uplink PPDU on the primary link and the PPDU on the non-primary link are transmitted synchronously.

In some embodiments, the AP MLD is a mobile AP MLD.

In a second aspect, a wireless communication method is provided and includes:

receiving, by a first non-access point station (non-AP STA) in a non-access point multilink device (non-AP MLD), a first information which is transmitted by an access point multilink device (AP MLD) on a primary link; or receiving, by the first non-AP STA device, the first information transmitted by an access point multilink device (AP MLD) on the primary link.

The first information is configured to indicate a length of an uplink physical layer protocol data unit (PPDU) that is synchronously transmitted on the primary link.

In some embodiments, the AP MLD is a mobile AP MLD.

In a third aspect, a wireless communication method is provided and includes:

receiving, by a second non-access point station (non-AP STA) in a second non-access point multilink device (non-AP MLD), a second information transmitted by an access point multilink device (AP MLD) on a non-primary link.

The second information is configured to share a transmission opportunity (TXOP), which is obtained by the AP MLD on the non-primary link, to the second non-AP STA; the second information is configured to indicate a length of an uplink physical layer protocol data unit (PPDU) synchronously transmitted on the non-primary link.

In some embodiments, the AP MLD is a mobile AP MLD.

In a fourth aspect, a wireless communication method is provided and includes:

transmitting, by an access point multilink device (AP MLD) on a primary link, a first information to a first non-access point station (non-AP STA) in a non-access point multilink device (non-AP MLD), and synchronously transmitting, by the AP MLD on a non-primary link, a second information to a second non-AP STA in the non-AP MLD.

The second information is configured to share a transmission opportunity (TXOP), which is obtained by the AP MLD on the non-primary link, to the second non-AP STA; the first information is configured to indicate a length of an uplink physical layer protocol data unit (PPDU) that is transmitted on the primary link, the second information is configured to indicate a length of an uplink PPDU that is transmitted on the non-primary link, and the indicated PPDUs are transmitted synchronously.

In a fifth aspect, a wireless communication method is provided and includes:

receiving, by a first non-access point station (non-AP STA) in a non-access point multilink device (non-AP MLD), a first information, which is transmitted on a primary link by an access point multilink device (AP MLD); and receiving, by a second non-AP STA in the non-AP MLD, a second information, which is synchronously transmitted on a non-primary link by the AP MLD.

The second information is configured to share a transmission opportunity (TXOP), which is obtained by the AP MLD on the non-primary link, to the second non-AP STA; the first information is configured to indicate a length of an uplink physical layer protocol data unit (PPDU) that is transmitted on the primary link, the second information is configured to indicate a length of an uplink PPDU that is transmitted on the non-primary link, and the indicated PPDUs are transmitted synchronously.

In a sixth aspect, a wireless communication method is provided and includes:

the non-AP MLD determining the primary link and the non-primary link according to the indication from the AP MLD while the non-AP MLD is establishing multilink connection with the AP MLD.

In a seventh aspect, a wireless communication device is provided to perform the method of the first aspect.

In detail, the wireless communication device comprises a functional module configured to perform the method in any one of the first aspect to the sixth aspect.

In an eighth aspect, a wireless communication device comprises a processor and a memory. The memory is configured to store a computer program, and the processor is configured to invoke and run the computer program stored in the memory to perform the method in any one of the first aspect to the sixth aspect.

In a ninth aspect, a device is provided to perform the method of any one of the first aspect to the sixth aspect.

In detail, the device comprises: a processor configured to invoke the computer program from memory and run the computer program to cause an apparatus, which is arranged with the device, to perform the method of any one of the first aspect to the sixth aspect.

In a tenth aspect, a computer-readable storage medium is provided and configured to store a computer program. The computer program is configured to cause a computer to perform the method of any one of the first aspect to the sixth aspect.

In an eleventh aspect, a computer program product comprises a computer program instruction. The computer program instruction is configured to cause a computer to perform the method of any one of the first aspect to the sixth aspect.

In a twelfth aspect, a computer program, when being run on a computer, is configured to cause the computer to perform the method of any one of the first aspect to the sixth aspect.

According to the present disclosure, the AP MLD shares the TXOPs obtained on the non-primary link to the second non-AP STA; indicates the length of the uplink PPDUs transmitted on the primary link and the non-primary link; and instructs the first non-AP STA and the second non-AP STA to perform uplink transmission synchronously. In the way, the uplink access restriction is relaxed, the success rate of synchronous uplink transmission in the AP MLD is improved without affecting transmission quality of the single-link device on the primary link, and the transmission service having the high throughput is provided.

### BRIEF DESCRIPTION OF THE DRAWINGS

FIG. 1 is a schematic view of a communication system architecture according to an embodiment of the present disclosure.

FIG. 2 is a schematic view showing a technical problem caused by the primary link and the non-primary link having a same access priority according to an embodiment of the present disclosure.

FIG. 3 is a schematic view of the mobile AP MLD performing downlink transmission according to an embodiment of the present disclosure.

FIG. 4 is another schematic view the mobile AP MLD performing downlink transmission according to an embodiment of the present disclosure.

FIG. 5 is a schematic view showing a technical problem of uplink transmission in an architecture in which the mobile AP MLD and the non-AP MLD are associated with each other, according to an embodiment of the present disclosure.

FIG. 6 is a schematic view showing a technical problem of uplink transmission in an architecture in which the mobile AP MLD, the legacy STA, and the legacy non-AP MLD are associated with each other, according to an embodiment of the present disclosure.

FIG. 7 is a flow chart showing interaction of a wireless communication method according to an embodiment of the present disclosure.

FIG. 8 is a schematic view of a network architecture according to an embodiment of the present disclosure.

FIG. 9 is a schematic view of another network architecture according to an embodiment of the present disclosure.

FIG. 10 is a schematic view of a frame structure of a control wrapper frame according to an embodiment of the present disclosure.

FIG. 11 is a schematic view of a frame structure of a BA frame according to an embodiment of the present disclosure.

FIG. 12 is a schematic view of uplink synchronous transmission according to an embodiment of the present disclosure.

FIG. 13 is another schematic view of uplink synchronous transmission according to an embodiment of the present disclosure.

FIG. 14 is another schematic view of uplink synchronous transmission according to an embodiment of the present disclosure.

FIG. 15 is another schematic view of uplink synchronous transmission according to an embodiment of the present disclosure.

FIG. 16 is another schematic view of uplink synchronous transmission according to an embodiment of the present disclosure.

FIG. 17 is another schematic view of uplink synchronous transmission according to an embodiment of the present disclosure.

FIG. 18 is another schematic view of uplink synchronous transmission according to an embodiment of the present disclosure.

FIG. 19 is another schematic view of uplink synchronous transmission according to an embodiment of the present disclosure.

FIG. 20 is another schematic view of uplink synchronous transmission according to an embodiment of the present disclosure.

FIG. 21 is another schematic view of uplink synchronous transmission according to an embodiment of the present disclosure.

FIG. 22 is a schematic diagram of a first non-AP MLD according to an embodiment of the present disclosure.

FIG. 23 is a schematic diagram of a first non-AP STA according to an embodiment of the present disclosure.

FIG. 24 is a schematic diagram of a first AP MLD according to an embodiment of the present disclosure.

FIG. 25 is a flow chart showing interaction of another wireless communication method according to an embodiment of the present disclosure.

FIG. 26 is a schematic view of still another network architecture according to an embodiment of the present disclosure.

FIG. 27 is a schematic view of uplink synchronous transmission between various Non AP STAs in the Non AP MLD according to an embodiment of the present disclosure.

FIG. 28 is another schematic view of uplink synchronous transmission between various Non AP STAs in the Non AP MLD according to an embodiment of the present disclosure.

FIG. 29 is another schematic view of uplink synchronous transmission between various Non AP STAs in the Non AP MLD according to an embodiment of the present disclosure.

FIG. 30 is another schematic view of uplink synchronous transmission between various Non AP STAs in the Non AP MLD according to an embodiment of the present disclosure.

FIG. 31 is another schematic view of uplink synchronous transmission between various Non AP STAs in the Non AP MLD according to an embodiment of the present disclosure.

FIG. 32 is another schematic view of uplink synchronous transmission between various Non AP STAs in the Non AP MLD according to an embodiment of the present disclosure.

FIG. 33 is another schematic view of uplink synchronous transmission between various Non AP STAs in the Non AP MLD according to an embodiment of the present disclosure.

FIG. 34 is a flow chart of a wireless communication method according to an embodiment of the present disclosure.

FIG. 35 is a schematic diagram of a wireless communication device according to an embodiment of the present disclosure.

FIG. 36 is a schematic diagram of another wireless communication device according to an embodiment of the present disclosure.

FIG. 37 is a schematic diagram of still another wireless communication device according to an embodiment of the present disclosure.

FIG. 38 is a schematic diagram of still another wireless communication device according to an embodiment of the present disclosure.

FIG. 39 is a schematic diagram of still another wireless communication device according to an embodiment of the present disclosure.

FIG. 40 is a schematic diagram of a communication device according to an embodiment of the present disclosure.

FIG. 41 is a schematic diagram of a chip according to an embodiment of the present disclosure.

### DETAILED DESCRIPTION

Technical solutions in the embodiments of the present disclosure will be described below by referring to the accompanying drawings in the embodiments of the present disclosure. Apparently, the described embodiments are a part of, but not all of, the embodiments of the present disclosure. All other embodiments obtained by any ordinary skilled person in the art without making creative work shall fall within the scope of the present disclosure.

Technical solutions of the embodiments of the present disclosure may be applied to various communication systems, such as Wireless Local Area Networks (WLAN), Wireless Fidelity (WiFi), or other communication systems.

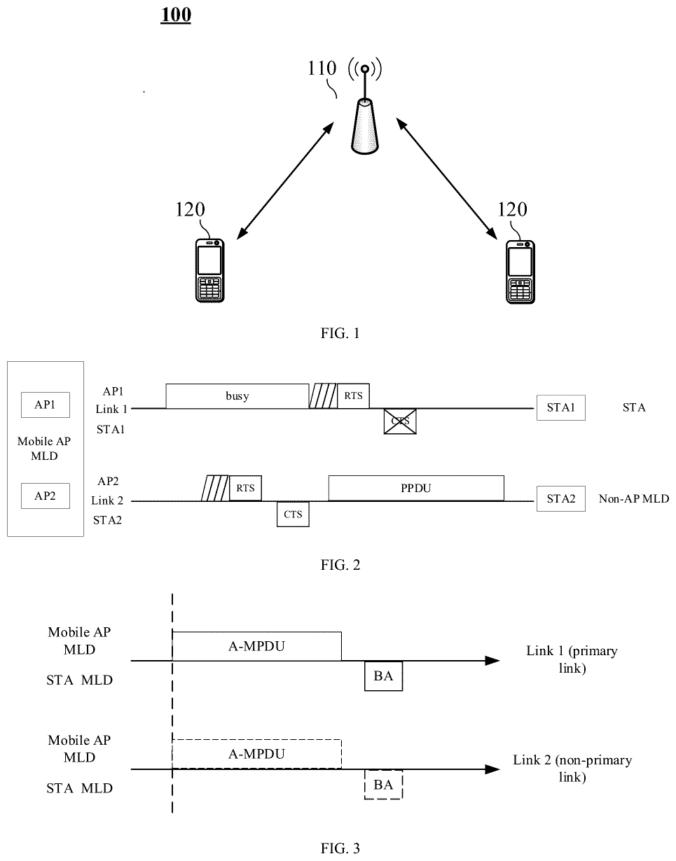

Exemplarily, the communication system 100 in the embodiments of the present disclosure is shown in FIG. 1. The communication system 100 may include an access point (AP) device 110, and a station (STA) device 120 that accesses a network via the AP device 110.

In embodiments of the present disclosure, the STA device may be deployed on land, including indoors or outdoors, handheld, wearable, or vehicle-mounted; or on water (such as on ships, and so on); and in the air (such as on airplanes, balloons, satellites, and so on).

In embodiments of the present disclosure, the STA device may be a mobile phone, a tablet computer, a computer having wireless transceiving function, a virtual reality (VR) device, an augmented reality (AR) device, a wireless device in industrial control, a wireless device in self-driving, a wireless device in remote medical, a wireless device in smart grid, a wireless device in transport safety, a wireless device in a smart city, or a wireless device in a smart home, and so on.

As an example but not limitation, in the embodiments of the present disclosure, the STA device may be a wearable device. The wearable device, which may be referred to as a wearable smart device, a is a generic term of a device which is intelligently designed and developed, by applying wearable technology, based on a daily wearable device, such as glasses, gloves, watches, clothing and shoes. The wearable device may be worn to a user or may be a portable device that is integrated into clothing or accessories of the user. The wearable device is not only a hardware device, but also achieve power functions through software support as well as data interaction and cloud interaction. Broadly speaking, the wearable smart device includes a full-featured and large-sized device that does not rely on a smart phone to achieve complete or partial function. For example, the wearable smart device may be a smart watch, smart glasses, and a smart bracelet and smart jewelries that focus on a certain type of application functionality and need to be used in conjunction with other devices such as smartphones to achieve purposes of monitoring physical signs.

FIG. 1 exemplarily shows one AP and two STAs. In some embodiments, the communication system 100 may include a plurality of APs and other numbers of STAs. The numbers of Aps and STAs are not limited herein.

It should be understood that the device having communication functions in the network/system of the embodiments of the present disclosure may be referred to as a communication device. Taking the communication system 100 illustrated in FIG. 1 as an example, the communication device may include an access point 110 and a station 120. The access point 110 and the station 120 may be specific devices as described above, which will not be repeated herein. The communication device may also include other devices in the communication system 100 such as a network controller, a gateway, and other network entities, which will not be limited in the embodiments of the present disclosure.

It should be understood that the terms “system” and “network” are often used interchangeably herein. The term “and/or” herein is merely a description of an association relationship of the mentioned objects. The term indicates that three relationships can exist. For example, A and/or B means A alone, A and B being present at the same time, and B alone. In addition, the character “/” herein generally indicates that the mentioned objects before and after the character are in an “or” relationship.

It should be understood that the “indication” in the embodiments of the present disclosure may be a direct indication, an indirect indication, or suggest an associated relationship between two entities. For example, A indicating B may mean that A directly indicates B, such as B obtains information through A; or A indirectly indicates B, such as A indicating C and B obtaining information through the C; there is an associative relationship between A and B.

Terms used in the embodiments of the present disclosure are used only for the purpose of explaining specific embodiments of the present disclosure and are not intended to limit the present disclosure. The terms “first”, “second”, “third” and “fourth” in the specification, claims and the drawings of the present disclosure are used to distinguish different objects and are not used to describe a particular order. In addition, terms “including”, “having”, and any variations thereof, are intended to cover non-exclusive inclusion.

In the description of the embodiments of the present disclosure, the term “corresponding” may indicate a direct or indirect corresponding relationship between two objects, or indicate an associated relationship between the two objects, or indicate a relationship of instructing and being instructed or a relationship of configuring and being configured.

In the embodiments of the present disclosure, “predefined” may be achieved by storing, in advance in a device (such as including a terminal device and a network device), corresponding codes, tables or other means that can be used to indicate relevant information. The present disclosure does not limit specific ways of achieving the predefining. For example, predefined information may mean information defined in a protocol.

In the embodiments of the present disclosure, the “protocol” may refer to a standard protocol in the field of communication, such as including the WiFi protocol and any related protocol to be applied in future WiFi communication systems. The present application does not limit the protocol.

In order to facilitate a better understanding of the embodiments of the present disclosure, technologies related to the present disclosure will be described.

The wireless local area network has a low cost, is flexible, and can be expanded easily, and therefore, the wireless local area network is used in enterprises, homes, and other scenarios. A kind of wireless product called “mobile access point (mobile AP)” is common in the market. Since there is no need to deploy a dedicated AP, the mobile AP may form a wireless network at almost any desired location, and the mobile AP has a low cost. Especially, the mobile AP is suitable for small offices and home environments to provide a cost-effective and fast networking for a small number of users. Further, the mobile AP is also suitable for construction sites, exhibitions, sports events and other places where temporary networking is required. In the multilink section of the draft 802.11be standard, an NSTR AP MLD operation mechanism is proposed and is and instantiated as a mobile AP MLD. The mobile AP MLD is usually arranged in a battery-powered mobile device. The mobile AP MLD is most commonly used as a Wi-Fi hotspot or a network sharing.

For the 802.11be, it is critical to have performance better than the traditional 802.11. For example, when a simultaneous transmitting and receiving (STR) access point multilink device (AP MLD) is connected to a simultaneous transmitting and receiving (STR) or non-simultaneous transmitting and receiving (NSTR) non-access point multilink device (non-AP MLD), more multilink gain may be obtained. However, a non-AP MLD, which is instantiated as the mobile AP MLD connection, does not have a STR capability. In addition, the mobile AP MLD is explicitly restricted in a proposed draft text (PDT) document about the mobile AP MLD. For example, links supported by the mobile AP MLD are divided into a primary link and a non-primary link. The mobile AP MLD communicates with a single-link device on the primary link only. A multilink device, which supports the 802.11be, may communicate with the mobile AP MLD on both the primary link and the non-primary link. In order to ensure transmission quality of the single-link device, the mobile AP MLD, if desiring to transmit on the non-primary link, must be a transmission opportunity (TXOP) holder on the primary link. Due to these access rules, it is much more difficult to obtain multilink gains in mobile AP MLD scenarios, and it is a challenge to improve multilink performance. Therefore, synchronous accessing needs to be designed and optimized for the mobile AP MLD of the NSTR.

For a STA MLD that supports the STR, each affiliated STA of the STA MLD may execute an EDCA competition mechanism independently, and clear channel assessment (CCA) detection among various affiliated STAs is not affected. Therefore, multilink aggregation technology may be achieved easily. However, an MLD, which does not support the STR and may be called a Non-STR MLD, has affiliated STAs, and a spacing between operating bands of these affiliated STAs is excessively small. Therefore, in device coexistence (IDC) interference may exist, causing the affiliated STAs to be unable to receive and transmit data at the same time, such that performance of the MLD device is limited. That is, when one STA is transmitting data, and another STA cannot receive data, such that multilink aggregation may not be achieved easily.

In order to facilitate a better understanding of the embodiments of the present disclosure, an NSTR AP operation process related to the present disclosure is described.

The mobile AP MLD cannot receive data on one link of an NSTR link pair while transmitting data on the other link of the NSTR link pair; or cannot transmit data on one link of an NSTR link pair while receiving data on the other link of the NSTR link pair. The mobile AP MLDs may be used to serve the STA MLD in the traditional 802.11be. The primary link and the non-primary link may be defined according to performance of the mobile AP MLD device itself, however, the single-link device communicates with the mobile AP MLD on the primary link only. In actual transmission, if an access priority of the non-primary link is the same as an access priority of the primary link, a problem as shown in FIG. 2 may occur. An AP1 and an AP2 are two affiliated APs in one mobile AP MLD. The AP2 on a link 2 (the non-primary link) obtains the TXOP firstly and starts downlink transmission. Subsequently, the AP1 on a link 1 obtains the TXOP and is ready to perform the downlink transmission. Since the mobile AP MLD is NSTR, the AP1 may be unable to receive a clear to send (CTS) replied by the STA1 on the link 1, such that the AP1 is unable to transmit downlink data to the single-link device. In order to ensure the transmission quality of the single-link device, it is specified that if the mobile AP MLD desires to perform transmission on the non-primary link, the mobile AP MLD must be the TXOP holder on the primary link.

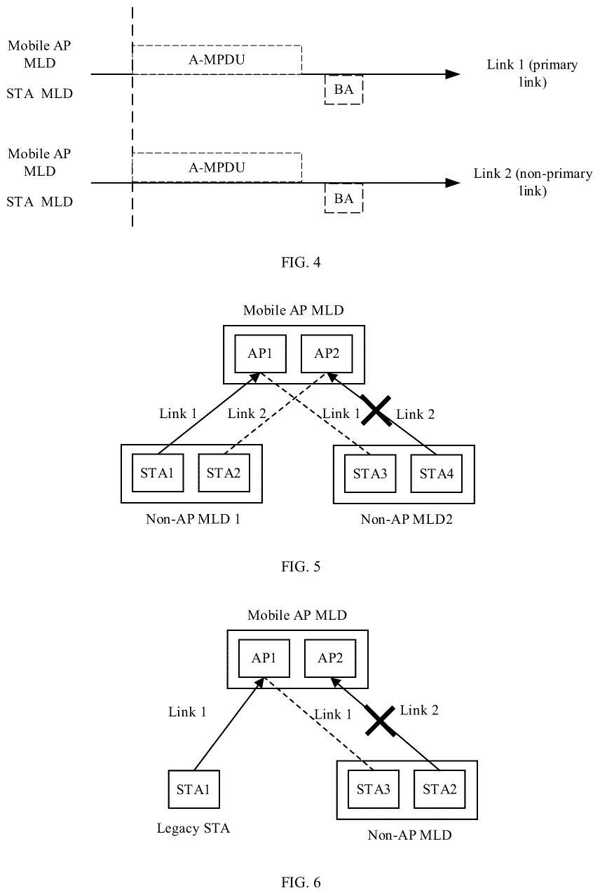

There are two cases for the downlink transmission of the mobile AP MLD. In the case 1, as shown in FIG. 3, after the mobile AP MLD has a right of accessing the primary link, it is checked whether the non-primary link is available or not. When the non-primary link is available, downlink transmission (such as, transmitting an aggregate medium access control protocol data unit (A-MPDU)) may be performed through the two links synchronously. When the non-primary link is not available, the downlink transmission (such as, transmitting the A-MPDU) may be performed on the primary link only. In the case 2, as shown in FIG. 4, after the mobile AP MLD has a right of accessing the non-primary link, it is checked whether the primary link is available or not. When the primary link is available, downlink transmission (such as, transmitting A-MPDU) may be performed through the two links synchronously. When the primary link is not available, the non-primary link abandons a current transmission opportunity, and an enhanced distributed channel access (EDCA) is reset.

To facilitate a better understanding of the embodiments of the present disclosure, specifications about the mobile AP MLD in the PDT related to the present disclosure will be explained.

The affiliated STA in the non-AP MLD is associated with an affiliated AP in the mobile AP MLD. When the STA desired to perform transmission on the non-primary link, the STA should comply with the “physical layer protocol data unit (PPDU) start time alignment” and comply with the following additional restrictions:
1. When only the STA of the non-AP MLD, serving as the TXOP holder on the primary link, initiates the PPDU, another affiliated STA of the non-AP MLD associated with the mobile AP may initiate PPDU transmission on the non-primary link.
2. When only the AP of the mobile AP MLD, serving as the TXOP holder on the primary link, initiates the PPDU, another affiliated AP of the mobile AP MLD associated with the non-AP STA may initiate the PPDU transmission on the non-primary link.

To facilitate a better understanding of the embodiments of the present application, the related art and drawbacks of the related art will be described.

In the mobile AP MLD scenario, when the mobile AP MLD has the right of accessing the primary link, it is checked whether the non-primary link is available. When the non-primary link is available, the downlink transmission is performed on the two links synchronously. When the non-primary link is not available, downlink transmission is performed on the primary link only. When the mobile AP MLD has the right of accessing the non-primary link, it is checked whether the primary link is available. When the primary link is available, the downlink transmission is performed on the two links synchronously. When the primary link is not available, the non-primary link abandons the current transmission opportunity, and EDCA is reset.

However, synchronous uplink transmission is not described in detail. According to the access rules for the mobile AP MLD described in the PDT, only when the STA of the non-AP MLD, serving as the TXOP holder on the primary link, initiates the PPDU, another affiliated STA of the non-AP MLD associated with the mobile AP can initiate the PPDU transmission on the non-primary link. In a scenario shown in FIG. 5, the mobile AP MLD has two affiliated AP devices, the AP1 and the AP2. The AP1 associates, on a link 1 (the primary link), with an STA1 in a non-AP MLD1 and an STA3 in a non-AP MLD2. The AP2 associates, on a link 2 (the non-primary link), with an STA2 in the non-AP MLD1 and an STA4 in the non-AP MLD2. When the STA4 desires to perform uplink transmission, the STA3 must be the TXOP holder of the link 1 (the primary link). When the uplink TXOP holder of the link 1 (the primary link) is the STA1, the entire non-AP MLD2 may be unable to perform uplink transmission. Therefore, when no uplink data is to be transmitted by the STA2, uplink resources on the link 2 (the non-primary link) may be wasted.

In another scenario, as shown in FIG. 6, the two affiliated APs of the mobile AP MLD associate, on the link 1 (the primary link), with the single-link device STA1 (legacy STA) and the STA3 in the non-AP MLD; and associate, on the link 2 (the non-primary link), with the STA2 in the non-AP MLD. According to the access rules for the mobile AP MLD in the PDT, when the STA2 desires to perform uplink transmission, the STA3 must be the TXOP holder of the link 1 (the primary link). When the uplink TXOP holder of the link 1 (the primary link) is the single-link device STA1, the entire non-AP MLD may be unable to perform the uplink transmission, such that uplink resources on the link 2 (the non-primary link) may be wasted.

In the above two scenarios, according to the access rules for the mobile AP MLD in the art, conditions that permit access may be excessively strict, and uplink resource utilization is low. Therefore, synchronous access of NSTR mobile AP MLDs may be designed and optimized in the present disclosure, such that access rules for the mobile AP MLD may be changed, restrictions on the uplink access may be relaxed. In the first scenario, as shown in FIG. 5, when the STA1 is the uplink TXOP holder of the link 1 (the primary link), the STA4 in the non-AP MLD2 may also perform uplink transmission synchronously with the STA1. In the second scenario, as shown in FIG. 6, when the STA1 is the uplink TXOP holder of the link 1 (the primary link), the STA2 in the non-AP MLD may also perform uplink transmission synchronously with the STA1. Finally, the success rate of uplink synchronous transmission in the mobile AP MLD may be improved without affecting the transmission quality of the single-link device, and the transmission service having the high throughput is provided.

Based on the above, the present disclosure provides a scheme for multilink device transmission. The AP MLD shares the TXOP obtained from the non-primary link to a second non-AP STA; restricts lengths of uplink PPDUs transmitted on the primary link and the non-primary link; and triggers the first non-AP STA and the second non-AP STA to perform synchronous uplink transmission. The uplink access restriction is relaxed, the success rate of uplink synchronous transmission in the AP MLD may be improved without affecting the transmission quality of the single-link device, and the transmission service having the high throughput is provided. In the way, in the AP MLD scenario, a plurality of independent non-APs are triggered to perform uplink transmission synchronously.

Technical solutions of the present disclosure are described in detail below based on specific embodiments.

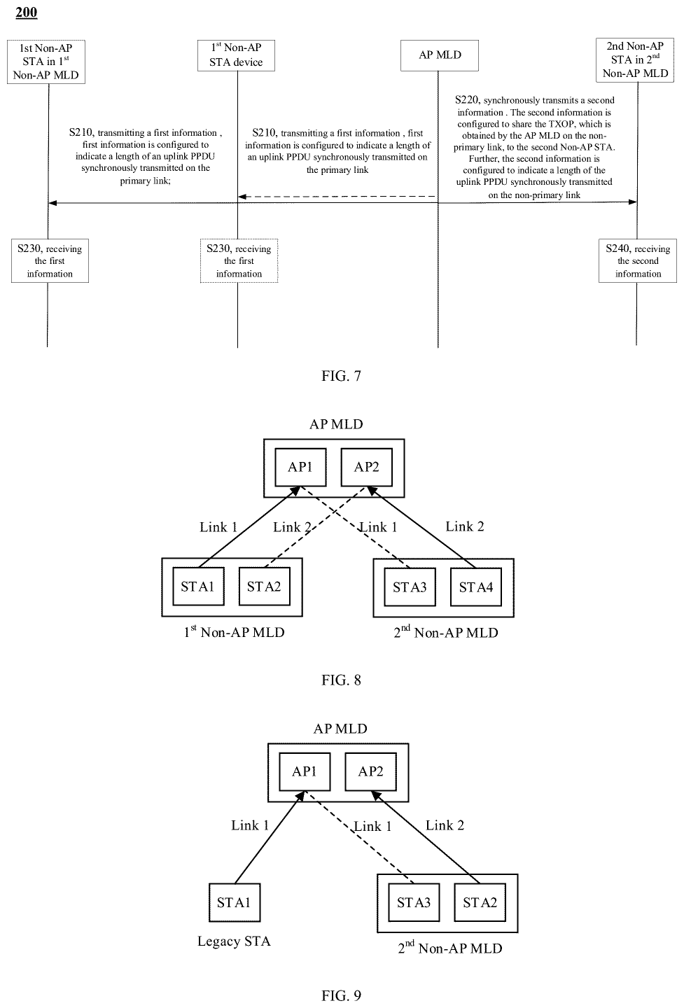

FIG. 7 is a schematic view showing interaction of a wireless communication method 200 according to an embodiment of the present disclosure.

As shown in FIG. 7, the wireless communication method 200 includes at least some of the following.

In S210, an AP MLD transmits a first information on a primary link to a first non-AP STA in the first non-AP MLD; alternatively, the AP MLD transmits the first information on the primary link to a first non-AP STA device. The first information is configured to indicate a length of an uplink PPDU synchronously transmitted on the primary link.

In S220, the AP MLD synchronously transmits a second information on a non-primary link to a second non-AP STA in a second non-AP MLD. The second information is configured to share the TXOP, which is obtained by the AP MLD on the non-primary link, to the second non-AP STA. Further, the second information is configured to indicate a length of the uplink PPDU synchronously transmitted on the non-primary link.

In S230, the first non-AP STA receives the first information.

In S240, the second non-AP STA receives the second information.

That is, the first information indicates the lengths of uplink PPDUs transmitted synchronously on the primary link; and the second information indicates the lengths of uplink PPDUs transmitted synchronously on the non-primary link.

In some embodiments, the first non-AP STA in the first non-AP MLD transmits uplink data on the primary link based on the first information. The second non-AP STA in the second non-AP MLD transmits uplink data on the non-primary link based on the second information. Alternatively, the first non-AP STA device transmits the uplink data on the primary link based on the first information, and the second non-AP STA in the second non-AP MLD transmits the uplink data on the non-primary link based on the second information.

The first information indicates the lengths of uplink PPDUs transmitted synchronously on the primary link, and the second information indicates the lengths of uplink PPDUs transmitted synchronously on the non-primary link. Therefore, the uplink data transmission, which is performed by the first non-AP STA in the first non-AP MLD based on the first information, and the uplink data transmission, which is performed by the second non-AP STA in the second non-AP MLD based on the second information, are performed synchronously. Alternatively, the uplink data transmission, which is performed by the first non-AP STA device based on the first information, and the uplink data transmission, which is performed by the second non-AP STA in that second non-AP MLD based on the second information, are performed synchronously.

In the embodiments of the present disclosure, the non-AP on the primary link may be a single-link non-AP (such as a legacy STA) or a non-AP in the non-AP MLD; and the non-AP on the non-primary link is the non-AP in the non-AP MLD.

In the embodiments of the present disclosure, in a scenario where the AP MLD and the non-AP MLD are associated with each other, the AP MLD may share the TXOP obtained by the AP MLD to a plurality of independent non-APs (i.e., a plurality of non-APs belonging to different non-AP MLDs, respectively).

In the embodiments of the present disclosure, the AP MLD includes at least one NSTR link pair, and one link pair of the at least one NSTR link pair includes the primary link and the non-primary link.

In some embodiments, the AP MLD is a mobile AP MLD. The following is illustrated when the AP MLD is the mobile AP MLD, i.e., terms the AP MLD and the mobile AP MLD in the following are different names for a same device.

Specifically, the non-AP MLD and the mobile AP MLD have NSTR link pairs. That is, the mobile AP MLD and the non-AP MLD associated with the mobile AP MLD cannot receive data on one link of one NSTR link pair, and at the same, transmit data on the other link of the one NSTR link pair. Alternatively, the mobile AP MLD and the non-AP MLD associated with the mobile AP MLD cannot transmit data on one link of one NSTR link pair, and at the same, receive data on the other link of the one NSTR link pair.

The embodiments of the present disclosure only exemplify a case where the mobile AP MLD has one primary link and one non-primary link. Of course, the present disclosure may also be applied to a case where the mobile AP MLD has a plurality of primary links and/or a plurality of non-primary links.

In some embodiments, the first non-AP MLD may include NSTR link pairs and STR link pairs.

In some embodiments, the second non-AP MLD may include NSTR link pairs and STR link pairs.

To be noted that the NSTR is generally for a pair of links, such as 5 GHz and 6 GHz. When the NSTR link pair is present in the mobile AP MLD, the mobile AP MLD cannot simultaneously transmit data on one link of the link pair and receive data on the other link of the link pair. When a 2.4 GHz and 6 GHz link pair is present in the mobile AP MLD, the mobile AP MLD may transmit data on one link of the link pair and receive data on the other link of the link pair at the same time. That is, the mobile AP MLD cannot transmit data and receive data at the same time only when the mobile AP MLD is operating on the NSTR link pair. The NSTR is not a property of the device, but a property of the link.

Further, to be noted that, whether a multilink device can simultaneously transmit data and receive data on an NSTR link pair is substantially dependent on performance of the device. For a normal AP MLD device, even if the normal AP MLD device is operating on the NSTR link pair, as long as the AP MLD can solve the problem of in-device coexistence (IDC) interference, the normal AP MLD device may simultaneously transmit data and receive data on the NSTR link pair. However, the mobile AP MLD does not have a capability of solving the problem of IDC interference, and therefore, the mobile AP MLD device cannot simultaneously transmit data and receive data on the NSTR link pair.

In some embodiments, in the S210 above, the AP MLD transmits the first information on the primary link to the first non-AP STA in the first non-AP MLD, and that is, the first non-AP STA is one non-AP STA in the first non-AP MLD. In the case, the network architecture used in the present embodiment may be as shown in FIG. 8, AP MLD devices have two affiliated APs, an AP1 and an AP2. The AP1 is associated, on the link 1 (the primary link), with the STA1 (i.e., the first non-AP STA) in the first non-AP MLD and the STA3 in the second non-AP MLD. The AP2 is associated, on the link 2 (the non-primary link), with the STA2 (i.e., the first non-AP STA) in the first non-AP MLD and the STA4 (i.e., the second non-AP STA) in the second non-AP MLD. Further, the link 1 and the link 2 form one NSTR link pair. Based on the present disclosure, while the STA1 (the first non-AP STA) in the first non-AP MLD is performing uplink transmission on the link 1, the STA4 (the second non-AP STA) in the second non-AP MLD may perform uplink transmission on the link 2 at the same time.

In some embodiment, in the above S210, the AP MLD transmits the first information to the first non-AP STA device on the primary link, and that is, the first non-AP STA is a single-link device (such as a legacy STA). In the case, the network architecture used in the present embodiment may be as shown in FIG. 9, AP MLD devices have two affiliated APs, the AP1 and the AP2. The AP1 is associated, on the link 1 (the primary link), with single-link device STA1 (i.e., the first non-AP STA device) and the STA3 in the second non-AP MLD. The AP1 is associated, on the link 2 (the non-primary link), with the STA2 (i.e., the second non-AP STA) in the second non-AP MLD. Further, the link 1 and the link 2 form one NSTR link pair. Based on the present disclosure, while the single-link device STA1 (the first non-AP STA) is performing uplink transmission on the link 1, the STA2 (the second non-AP STA) in the second non-AP MLD may perform uplink transmission on the link 2 at the same time.

In some embodiments, the first information is carried by a frame that is configured to reply to data transmission, and/or, the second information is carried by a frame that is transmitted after the TXOP is obtained.

In some embodiments, the frame that is configured to reply to data transmission includes a control wrapper frame or a block acknowledgement (BA) frame.

In some embodiments, the frame, which is transmitted after the TXOP is obtained, includes a trigger frame or a multiple users request-to-send (MU-RTS) frame.

In some embodiments, the first information is transmitted via the control wrapper frame. In the case, for example, the second information is transmitted via the trigger frame or the MU-RTS frame.

In some embodiments, the first information is transmitted via the control wrapper frame, and the second information is transmitted via the trigger frame or the MU-RTS frame. Specifically, the control wrapper frame includes a high throughput (HT) control field. An aggregation control (A-Control) sub-field in the HT control field includes an uplink synchronization indication sub-field and an uplink length sub-field. A value of the uplink synchronization indication sub-field is configured to instruct the first non-AP STA to perform synchronous uplink transmission. A value of the uplink length sub-field is the same as a value of the uplink length sub-field carried in the trigger frame or in the MU-RTS frame (i.e., a length of the uplink PPDU, which is indicated by the first information to be synchronously transmitted on the primary link, is the same as a length of the uplink PPDU, which is indicated by the second information to be synchronously transmitted on the non-primary link). Further, the control wrapper frame includes a carried frame field. The carried frame field includes the BA frame sub-field. The BA frame sub-field is configured to acknowledge the first PPDU that is previously transmitted by the first non-AP STA.

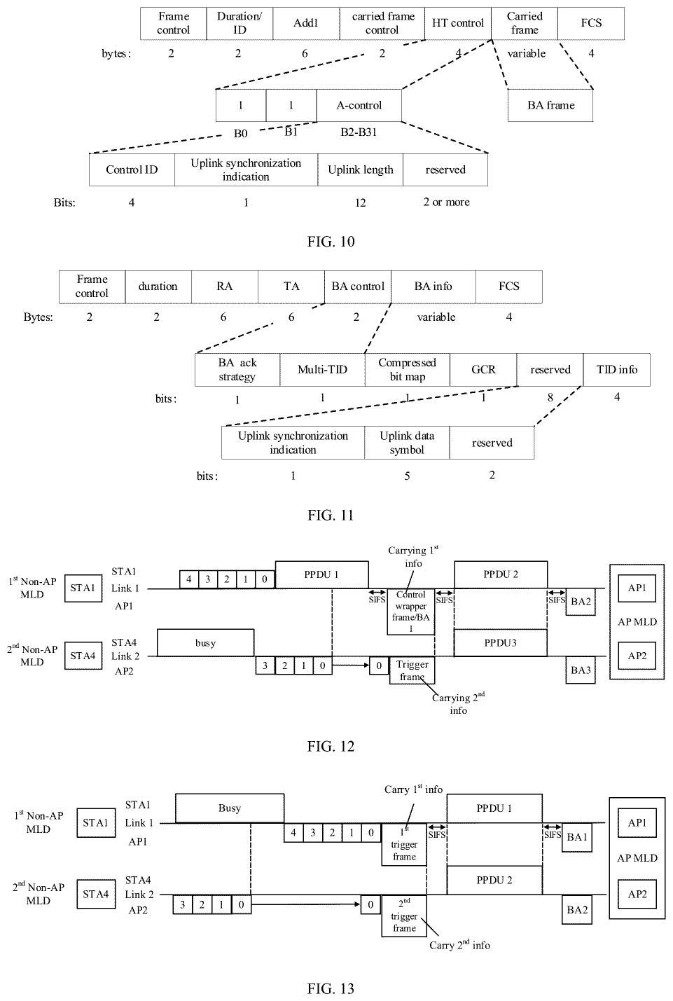

Specifically, a frame structure of the control wrapper frame may be as shown in FIG. 10, the carried frame field of the control wrapper frame is configured to carry a field following a field of a BA address 1 to achieve functions of the BA (that is, the first PPDU previously transmitted by the first non-AP STA is acknowledged). The first information is included in the A-Control sub-field of the HT control field in the control wrapper frame. The first information substantially includes a 4-bit control ID, a 1-bit uplink synchronization indication (US indication), a 12-bit uplink length, and 2 or more (not more than 13 bits, since the A-Control length is 30 bits) reserved bits. In the first information, the control ID is a fixed value of “0111”, indicating that a subsequent sub-field is configured to indicate information to be synchronously uplink transmitted. The uplink synchronization indication sub-field is 1 bit in length, indicating that the AP MLD requests the first non-AP STA to subsequently perform synchronous uplink transmission. Specifically, when the AP MLD requests the first non-AP STA to subsequently perform synchronous uplink transmission, the AP MLD may set a corresponding bit to be “1”. When the AP MLD does not request the first non-AP STA to subsequently perform synchronous uplink transmission, the AP MLD may set the corresponding bit to be “0”. The uplink length sub-field is 12 bits in length. The value of the uplink length sub-field is the same as the value of the uplink length sub-field, which is carried by the trigger frame or the MU-RTS frame carrying the second information. The value of the uplink length sub-field is used by the AP MLD to limit the length of the PPDU, which will be used by the first non-AP STA to subsequently perform the synchronous uplink transmission.

Specifically, as shown in FIG. 10, the control wrapper frame may include the following fields:

a frame control (occupying 2 bytes), a duration/ID (occupying 2 bytes), an address 1 (occupying 6 bytes), a carried frame control (occupying 2 bytes), a HT control (occupying 4 bytes), a carried frame (occupying variable numbers of bytes), a frame check sequence (FCS) (occupying 4 bytes).

In some embodiments, the first information is transmitted by the control wrapper frame, and the second information is transmitted by the trigger frame or the MU-RTS frame. Specifically, the control wrapper frame includes the high throughput control field. The aggregation control sub-field in the HT control field includes an uplink data symbol sub-field. A length of an uplink PPDU indicated by the uplink data symbol sub-field is the same as the length of the uplink PPDU indicated by the uplink length sub-field carried in the trigger frame or in the MU-RTS frame carrying the second information. Further, the control wrapper frame includes a carried frame field, the carried frame field includes the BA frame sub-field, the BA frame sub-field is configured to acknowledge the first PPDU previously transmitted by the first non-AP STA.

Specifically, the carried frame field of the control wrapper frame is configured to carry any field following the field of the BA1 address 1 to achieve functions of the BA1 (i.e., acknowledging the first PPDU previously transmitted by the first non-AP STA). The A-Control sub-field of the HT control field included in the control wrapper frame is set to be a triggered response scheduling (TRS) control having a control ID of “0000”. The TRS control is a control field introduced in the 802.11ax standard, and a format of the TRS control is not changed in the present disclosure. An uplink data symbol sub-field included in the TRS control enables the AP MLD to limit the length of the PPDUs, which will be used by the first non-AP STA to perform the subsequent synchronous uplink transmission. For example, the length of the uplink PPDUs indicated by the uplink data symbol sub-field is the same as the length of the uplink PPDU indicated by the uplink length sub-field carried in the trigger frame or in the MU-RTS frame that carries the second information. In the way, two different non-AP MLDs (i.e., the first non-AP MLD and the second non-AP MLD) may subsequently transmit PPDUs having a same length.

In some embodiments, the first information is transmitted via the BA frame, and the second information is transmitted via the trigger frame or the MU-RTS frame. Specifically, the BA frame includes the BA control field, a reserved sub-field in the BA control field includes the uplink synchronization indication sub-field and the uplink data symbol sub-field. The value of the uplink synchronization indication sub-field is configured to instruct the first non-AP STA to perform synchronous uplink transmission. The length of the uplink PPDU indicated by the uplink data symbol sub-field is the same as the length of the uplink PPDU indicated by the uplink length sub-field carried in the trigger frame or in the MU-RTS frame.

Specifically, the frame structure of the BA frame may be as shown in FIG. 11, and the BA frame may include following fields.

A frame control, a duration, a receiver address (RA), a transmitter address (TA), a BA control, a BA information, an FCS. In some embodiments, as shown in FIG. 11, the number of bytes occupied by each of the above fields is 2, 2, 6, 6, 2, variable, and 4, respectively.

As shown in FIG. 11, the BA control field of the BA frame may further include the following sub-fields:

A BA ACK Policy, a multi-traffic identification (TID), a compressed bitmap, a groupcast with retries (GCR), a reserved sub-field, and a sub-field of TID information (TID_INFO). In some embodiments, as shown in FIG. 11, the number of bits occupied by each of the above sub-fields is 1, 1, 1, 1, 8, and 4, respectively. That is, the reserved sub-field may occupy B11 to B4 in the BA control field.

Specifically, the uplink synchronization (US) indication sub-field is 1 bit in length, indicating that the AP MLD requests the first non-AP STA to subsequently perform synchronous uplink transmission. Specifically, when the AP MLD requires the first non-AP STA to subsequently perform synchronous uplink transmission, the AP MLD may set a corresponding bit to be “1”. When the AP MLD does not require the first non-AP STA to subsequently perform synchronous uplink transmission, the AP MLD may set the corresponding bit to be “0”. The uplink data symbol sub-field is 5 bits in length. A function of the uplink data symbol sub-field is consistent with the function of the uplink data symbol sub-field in the TRS control in the 802.11ax standard, and indicates the number of orthogonal frequency-division multiplexing (OFDM) symbols in a data field of a subsequent data frame. The uplink data symbol sub-field is set to be the number of OFDM symbols minus one. The AP MLD may limit, based on the uplink data symbol sub-field, the length of the PPDU which is used by the first non-AP STA to perform subsequent synchronous uplink transmission.

In some embodiments, a backoff counter maintained by the first non-AP STA is decremented to reach zero firstly, and a backoff counter maintained by an AP device on the non-primary link of the AP MLD is decremented to reach zero subsequently. That is, the first non-AP STA obtains the TXOP firstly, and subsequently, the AP device on the non-primary link in the AP MLD obtains the TXOP.

In some embodiments, the backoff counter maintained by the AP device on the non-primary link in the AP MLD stops backing off while the AP device on the primary link in the AP MLD is transmitting the CTS frame. Further, after the AP device on the primary link in the AP MLD finishes transmitting the CTS frame, the backoff counter maintained by the AP device on the non-primary link in the AP MLD continues to be decremented.

In some embodiments, the backoff counter maintained by the AP device on the non-primary link of the AP MLD is decremented to reach zero firstly, and the backoff counter maintained by the first non-AP STA is decremented to reach zero subsequently. That is, the AP device on the non-primary link in the AP MLD obtains the TXOP firstly, and subsequently, the first non-AP STA obtains the TXOP.

In some embodiments, the AP device on the non-primary link of the AP MLD keeps the backoff counter, which is maintained by the AP device, at zero, after the backoff counter maintained by the AP device on the non-primary link of the AP MLD is decremented to reach zero, and before the AP MLD synchronously transmits the second information to the second non-AP STA on the non-primary link.

In some embodiments, when the backoff counter maintained by the first non-AP STA is decremented to reach zero, the first non-AP STA transmits uplink data on the obtained TXOP synchronously with other non-APs in the first non-AP MLD. Alternatively, the first non-AP STA transmits uplink data on the obtained TXOP.

In some embodiments, the first information is transmitted via a first frame, and the second information is transmitted via a second frame. The value of the uplink length sub-field carried in the first frame is the same as the value of the uplink length sub-field carried in the second frame.

In some embodiments, the first frame is the trigger frame or the MU-RTS frame, and/or, the second frame is the trigger frame or the MU-RTS frame.

In some embodiments, the backoff counter maintained by the AP device on the non-primary link in the AP MLD is decremented to reach zero firstly, and the backoff counter maintained by the AP device on the primary link in the AP MLD is decremented to reach zero subsequently. That is, the AP device on the non-primary link in the AP MLD obtains the TXOP firstly, and subsequently, the AP device on the primary link in the AP MLD obtains the TXOP.

In some embodiments, the AP device on the non-primary link in the AP MLD keeps the backoff counter, which is maintained by the AP device, at zero, after the backoff counter maintained by the AP device on the non-primary link in the AP MLD is decremented to reach zero and before the AP MLD synchronously transmits the second information to the second non-AP STA on the non-primary link in the AP MLD.

In some embodiments, the AP device on the non-primary link in the AP MLD keeps the backoff counter, which is maintained by the AP device, at zero, after the backoff counter maintained by the AP device on the non-primary link in the AP MLD is decremented to reach zero and before the AP MLD transmits the MU-RTS frame on the non-primary link to the second non-AP STA.

In some embodiments, when the backoff counter maintained by the AP device on the primary link in the AP MLD is decremented to reach zero, the AP MLD performs synchronous downlink transmission on the primary link and on the non-primary link.

In some embodiments, when the backoff counter maintained by the AP device on the primary link in the AP MLD is decremented to reach zero and the first non-AP STA and/or the second non-AP STA has uplink data that is to be transmitted urgently, the AP MLD abandons synchronous downlink transmission on both the primary link and the non-primary link.

In some embodiments, the AP MLD shares the TXOP, which is obtained by the AP MLD on the non-primary link, to the second non-AP STA based on the request from the first non-AP STA.

In some embodiments, the first non-AP MLD determines, based on the instruction of the AP MLD, the primary link and the non-primary link while the first non-AP MLD is establishing the multilink connection with the AP MLD; and/or the second non-AP MLD determines, based on the instruction of the AP MLD, the primary link and the non-primary link while the second non-AP MLD is establishing multilink connection with the AP MLD.

In some embodiments, corresponding to the network architecture shown in FIG. 8 above, as shown in FIG. 12, the backoff counter of the non-AP (STA1) on the primary link reaches zero firstly, and the backoff counter of the AP device (AP2) on the non-primary link reaches zero subsequently. The STA1 (the first non-AP STA) and the STA4 (the second non-AP STA) may transmit uplink data synchronously based on the following S a-1 to S a-7.

In S a-1, the affiliated non-AP STAT in the first non-AP MLD executes the EDCA mechanism on the link 1 (the primary link), the backoff counter is decremented to reach zero, and the affiliated non-AP STA1 obtains a transmission opportunity. In this case, the first non-AP MLD checks whether the affiliated non-AP STA2 has a demand of performing uplink transmission on the link 2 (the non-primary link) and whether the backoff counter is decremented to reach zero. When the affiliated non-AP STA2 has the demand of performing uplink transmission on the link 2 (the non-primary link) and the backoff counter is decremented to reach zero, synchronous uplink transmission within the same multilink device is performed according to the multilink channel access rules. When the affiliated non-AP STA2 does not have the demand of performing uplink transmission on the link 2 (the non-primary link) and/or the backoff counter is decremented to reach zero, the STA1 transmits uplink data to the affiliated AP1 in the AP MLD.

In S a-2, the affiliated AP2 in the AP MLD executes the EDCA mechanism on the link 2 (non-primary link), and the backoff counter is decremented to reach zero. In this case, according to the access rules for the AP MLD, the AP MLD is not the TXOP holder on the primary link, and therefore, the AP2 keeps the backoff counter at zero according to the multilink channel access rules.

In S a-3, the AP1 and the AP2 are in the same AP MLD, and therefore, the AP1 and the AP2 may interact information with each other. When the STA4, which is associated with the affiliated AP2 in the AP MLD, has uplink data to be transmitted, the AP1 is ready to start performing synchronous uplink transmission after receiving the PPDU1 on the link 1 (the primary link), and the AP2 generates the second information configured to trigger the STA4 to perform the uplink transmission. The second information is transmitted via the trigger frame (the uplink length sub-field in the trigger frame may limit the length of the uplink PPDUs subsequently transmitted by the STA4). The AP1 generates the first information and acknowledges the PPDU1. The information (the first information and the acknowledgement information (i.e., the BA1) for the PPDU1) are included in the control wrapper frame or in the BA frame and may be set in three manners, such as a manner 1 to a manner 3, as follows.

In a manner 1, the first information is added to the A-Control sub-field of the HT control field of the control wrapper frame. The carried frame field of the control wrapper frame is configured to carry any field following the field of the BA1 address 1, and the function of the BA1 (acknowledgement of PPDU1) may be achieved. The first information is included in the A-Control sub-field of the HT control field included in the control wrapper frame and substantially includes a 4-bit Control ID, a 1-bit uplink synchronization indication, a 12-bit uplink length, and 2 or more (no more than 13 bits, since the A-Control length is 30 bits) reserved bits. In the present embodiment, the 4-bit Control ID is set to be 0111 (indicating that the subsequent sub-field is configured to indicate synchronous uplink transmission). The 1-bit uplink synchronization indication is set to be 1 (the AP MLD requires the STA1 to subsequently perform synchronous uplink transmission). A value of the 12-bit uplink length to be the same as the value of the uplink length sub-field carried by the trigger frame transmitted by the AP2 on the link 2 (the non-primary link).

In a manner 2, the A-Control sub-field of the HT Control field of the control wrapper frame takes the uplink data symbol sub-field of the existing TRS control field as the first information. The carried frame field of the control wrapper frame is configured to carry any field following the field of the BA1 address 1 to achieve functions of the BA1 (acknowledgement of PPDU1). The A-Control sub-field of the HT control field included in the control wrapper frame is set to a TRS control having the control ID of “0000”. The TRS control is the Control field present in the 802.11ax standard and will not be changed in the present disclosure. The uplink data symbol sub-field included in the TRS control enables the AP MLD to limit the length of PPDU used by the STA1 to subsequently perform the synchronous uplink transmission. In the present embodiment, the value of the uplink data symbol sub-field is set by the AP1, and the AP2 sets the value of the uplink length sub-field carried by the trigger frame. In this way, PPDUs transmitted by two different non-AP multilink devices (the STA1 and the STA4) may have a same length.

In a manner 3, the first information is added to the reserved sub-field included in the BA Control field of the BA1 frame. Specifically, in the reserved sub-field of the BA Control field of the BA1 frame, the first information substantially includes a 1-bit uplink synchronization indication, a 5-bit uplink data symbol, and 2 reserved bits. In the present embodiment, the 1-bit uplink synchronization indication is set to be 1. In the present embodiment, the 5-bit uplink data symbol is set to a value to indicate a length equal to the length of the subsequent PPDU indicated by the uplink length sub-field carried by the trigger frame transmitted by the AP2 (i.e., the length of the subsequent PPDU that the AP1 instructs the STA1 to transmit via the uplink data symbol sub-field is the same as the length of the subsequent PPDU that the AP2 instructs the STA4 to transmit via the uplink length sub-field).

In S a-4, when the AP1 replies to the control wrapper frame or the BA1 frame on the link 1 (the primary link), the AP2 synchronously transmits the trigger frame on the link 2 (the non-primary link) (to ensure that an end time of the frame transmitted by the AP1 is aligned with an end time of the frame transmitted by the AP2).

In S a-5, when the STA1 receives the control wrapper frame on the link 1 (primary link), the STA1 parses the first information in the A-Control sub-field. When the first information is set by the manner 1 in Sa-3, the STA1 determines whether the uplink synchronization indication sub-field is 1. When the uplink synchronization indication sub-field is 1, it indicates that the AP MLD instructs the STA1 to subsequently perform synchronous uplink transmission. The STA1 further parses the uplink length sub-field and sets the length of the to-be-transmitted PPDU according to content of the uplink length sub-field. When the first information is set in the manner 2 in Sa-3, the STA1 parses the uplink data symbol sub-field in the TRS Control field and sets the length of the to-be-transmitted PPDU according to content of the uplink data symbol sub-field. When the STA1 receives the BA1 frame on the link 1 (primary link), the STA1 parses the first information in the reserved sub-field of the BA control sub-field and determines whether the US indication sub-field is 1. When the US indication sub-field is 1, it indicates that the AP MLD instructs the STA1 to subsequently perform the synchronous uplink transmission. The STA1 further parses the uplink data symbol sub-field, and sets the length of the to-be-transmitted PPDU according to content of the uplink data symbol sub-field.

In S a-6, the STA4, after receiving the trigger frame on the link 2 (non-primary link), parses the uplink length sub-field in the trigger frame and sets the length of the subsequently to-be-transmitted PPDU according to content of the uplink length sub-field.

In S a-7, the STA1 and the STA4 synchronously transmit uplink PPDU2 and PPDU3 of the same length, after the STA1 receives a short inter frame space (SIFS) time of the control wrapper frame and the STA4 receives a short inter frame space (SIFS) time of the trigger frame.

In some embodiments, corresponding to the network architecture shown in FIG. 8 above, as shown in FIG. 13, the backoff counter of the AP device (AP2) on the non-primary link reaches zero firstly, and the backoff counter of the non-AP (STA1) on the primary link reaches zero subsequently. The STA1 (the first non-AP STA) and the STA4 (the second non-AP STA) may transmit uplink data synchronously based on S b-1 to S b-6 as follows.

In S b-1, the affiliated AP2 in the AP MLD executes the EDCA mechanism on the link 2 (non-primary link), and the backoff counter is decremented to reach zero. In this case, according to the access rules for the AP MLD, the AP MLD is not the TXOP holder on the primary link, and therefore, the AP2 keeps the backoff counter at zero according to the multilink channel access rules.

In S b-2, the affiliated AP1 in the AP MLD executes the EDCA mechanism on the link 1 (the primary link), the backoff counter is decremented to reach zero, and the affiliated AP1 obtains the transmission opportunity. In this case, the AP MLD checks whether the affiliated AP2 has a demand of performing downlink transmission on the link 2 (the non-primary link). When the affiliated AP2 has the demand of performing downlink transmission on the link 2, the affiliated AP2 may perform the downlink synchronous transmission in conjunction with the multilink channel access rules. When the STA1, which is associated with the AP1, or the STA4, which is associated with the AP2, have a large amount of uplink data to be transmitted urgently, the affiliated AP1 and AP2 in the AP MLD abandon the downlink transmission opportunity, and uplink synchronous transmission may be triggered by a subsequent operation.

In S b-3, the AP1 and the AP2 are in a same AP MLD, and therefore, the AP1 and the AP2 may interact information with each other. The AP1 generates the first information configured to trigger STA1 to perform uplink transmission. The first information is transmitted via the first trigger frame (the uplink length sub-field in the first trigger frame may limit the length of the uplink PPDU that will be transmitted by the STA1 subsequently). The AP2 generates the second information configured to trigger the STA4 to perform uplink transmission. The second information is transmitted via the second trigger frame (the uplink length sub-field in the second trigger frame may limit the length of the uplink PPDU that will be subsequently transmitted by the STA4). Specifically, the uplink length sub-field in the first trigger frame and the uplink length sub-field in the second trigger frame are set to the same value.

In S b-4, when the AP1 transmits the first trigger frame on the link 1 (primary link), the AP2 synchronously transmits the second trigger frame on the link 2 (non-primary link) (to ensure that an end time of the frame transmitted by the AP1 is aligned with an end time of the frame transmitted by the AP2).

In S b-5, the STA1, after receiving the first trigger frame on the link 1 (primary link), parses the uplink length sub-field in the first trigger frame and sets the length of the subsequently to-be-transmitted PPDU according to the content of the uplink length sub-field. The STA4, after receiving the second trigger frame on the link 2 (non-primary link), parses the uplink length sub-field in the second trigger frame and sets the length of the subsequently to-be-transmitted PPDU according to the content of the uplink length sub-field.

In S b-6, the STA1 and the STA4 synchronously transmit the uplink PPDU2 and the PPDU3 of the same length, after the STA1 receives the SIFS time of the trigger frame and the STA4 receives the SIFS time of the trigger frame.

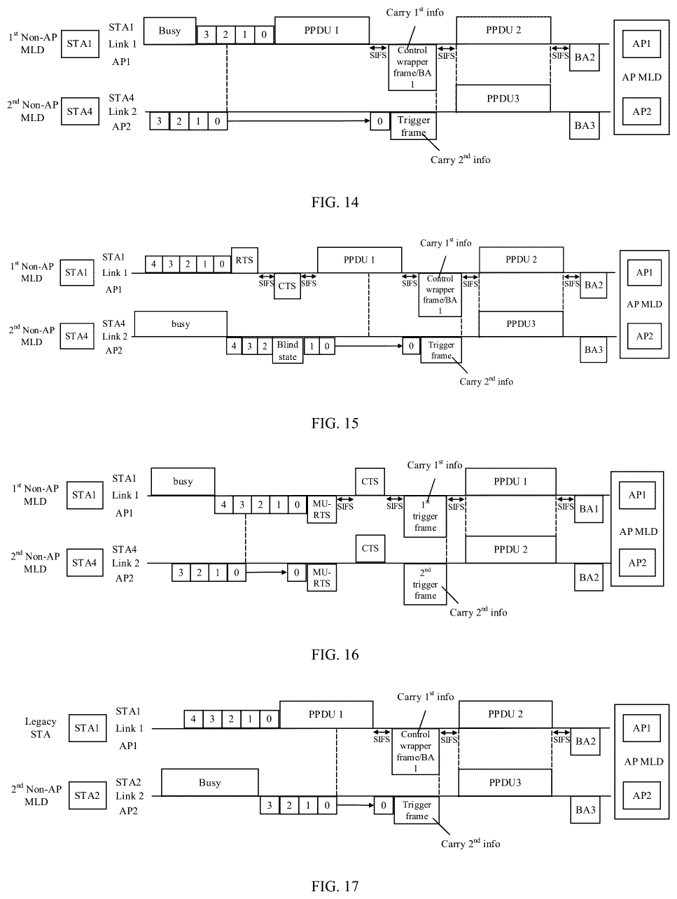

In some embodiments, corresponding to the network architecture shown in FIG. 8 above, as shown in FIG. 14, the backoff counter of the AP device (AP2) on the non-primary link reaches zero firstly, and the backoff counter of the non-AP (STA1) on the primary link reaches zero subsequently. The STA1 (the first non-AP STA) and the STA4 (the second non-AP STA) may transmit uplink data synchronously based on the following S c-1 to S c-7.

In S c-1, the affiliated AP2 in the AP MLD executes the EDCA mechanism on the link 2 (non-primary link), and the backoff counter is decremented to reach zero. In this case, according to the access rules for the AP MLD, the AP MLD is not the TXOP holder on the primary link, and therefore, the AP2 keeps the backoff counter at zero according to the multilink channel access rules.

In S c-2, the affiliated non-AP STA1 in the first non-AP MLD executes the EDCA mechanism on the link 1 (the primary link), the backoff counter is decremented to reach zero, and the affiliated non-AP STA1 obtains the transmission opportunity. In this case, the first non-AP MLD checks whether the affiliated non-AP STA2 has a demand of performing uplink transmission on the link 2 (the non-primary link) and whether the backoff counter is decremented to reach zero. When the affiliated non-AP STA2 has the demand of performing uplink transmission on the link 2 and the backoff counter is decremented to reach zero, uplink synchronous transmission within the same multilink device is performed according to the multilink channel access rules. When the affiliated non-AP STA2 does not have the demand of performing uplink transmission on the link 2 and/or the backoff counter is not decremented to reach zero, the STA1 normally transmits the uplink data to the affiliated AP1 in the AP MLD.

The subsequent operations S c-3 to S c-7 are the same as the operations S a-3 to S a-7, respectively and will not be repeated herein.

In some embodiments, corresponding to the network architecture shown in FIG. 8 above, as shown in FIG. 15, a request-to-send (RTS) and CTS exchanging scenario are considered. The backoff counter of the non-AP (STA1) on the primary link reaches zero firstly, and the backoff counter of the AP device (AP2) on the non-primary link reaches zero subsequently. The STA1 (the first non-AP STA) and the STA4 (the second non-AP STA) may transmit uplink data synchronously based on the following Sd-1 to Sd-7.

In S d-1, the affiliated non-AP STA1 in the first non-AP MLD executes the EDCA mechanism on the link 1 (the primary link), the backoff counter is decremented to reach zero, and the affiliated non-AP STA1 obtains the transmission opportunity. In this case, the first non-AP MLD checks whether the affiliated non-AP STA2 has the demand of performing uplink transmission on the link 2 (the non-primary link) and whether the backoff counter is decremented to reach zero. When the affiliated non-AP STA2 has the demand of performing uplink transmission on the link 2 and the backoff counter is decremented to reach zero, uplink synchronous transmission within the same multilink device is performed according to the multilink channel access rules. When the affiliated non-AP STA2 does not have the demand of performing uplink transmission on the link 2 or the backoff counter is not decremented to reach zero, the STA1 normally transmits the uplink data to the affiliated AP1 in the AP MLD, and the RTS and CTS exchanging process may be included.

In S d-2, the affiliated AP2 in the AP MLD executes the EDCA mechanism on the link 2 (non-primary link). When the AP1 transmits the CTS on the link 1 (primary link), due to the NSTR characteristics of the link 1 and the link 2, while the CTS is being transmitted, the AP2 may be in a blind state, and the backoff counter stops being decremented. After AP1 finishes transmitting the CTS, the AP2 exits the blind state, and the backoff counter continues to be decremented. When the backoff counter is decremented to reach zero, at this moment, the AP1 in the AP MLD is receiving data on the link 1, and therefore, the AP2 cannot transmit the downlink data due to the NSTR characteristics of the link 1 and the link 2. The AP2 maintains the backoff counter at zero according to the multilink channel access rules.

The subsequent operations S d-3 to S d-7 are the same as the operations S a-3 to S a-7, respectively, and will not be repeated herein.

In some embodiments, corresponding to the network architecture shown in FIG. 8 above, as shown in FIG. 16, in the RTS and CTS exchanging scenario, the backoff counter of the AP device (AP2) on the non-primary link reaches zero firstly, and the backoff counter of the non-AP (STA1) on the primary link reaches zero subsequently. The STA1 (the first non-AP STA) and the STA4 (the second non-AP STA) may synchronously transmit uplink data based on the following S e-1 to S e-6.

In S e-1, the affiliated AP2 in the AP MLD executes the EDCA mechanism on the link 2 (non-primary link), and the backoff counter is decremented to reach zero. In this case, according to the access rules for the AP MLD, the AP MLD is not the TXOP holder on the primary link, and therefore, the AP2 keeps the backoff counter at zero according to the multilink channel access rules.

In S e-2, the affiliated AP1 in the AP MLD executes the EDCA mechanism on the link 1 (the primary link), the backoff counter is decremented to reach zero, and the affiliated AP1 obtains the transmission opportunity. In this case, the AP MLD checks whether the affiliated AP2 has a demand of performing downlink transmission on the link 2 (the non-primary link). When the affiliated AP2 has the demand of performing downlink transmission on the link 2, synchronous downlink transmission may be performed in conjunction with the multilink channel access rules of the AP MLD. When the STA1, which is associated with the AP1, and the STA4, which is associated with the AP2, have a large amount of uplink data to be transmitted urgently, the affiliated AP1 and AP2 in the AP MLD abandon the downlink transmission opportunity, and the uplink synchronous transmission may be triggered through subsequent operations.

In S e-3, the AP1 and the AP2 are in the same AP MLD, the AP1 and the AP2 may interact information with each other. The AP1 generates the first information configured to trigger the STA1 to perform uplink transmission. The first information is transmitted via the first trigger frame (the uplink length sub-field in the first trigger frame may limit the length of the uplink PPDU that will be subsequently transmitted by the STA1). The AP2 generates the second information configured to trigger the STA4 to perform uplink transmission. The second information is transmitted via the second trigger frame (the uplink length sub-field in the second trigger frame may limit the length of the uplink PPDU that will be subsequently transmitted by the STA4). Specifically, the uplink length sub-field in the first trigger frame and the uplink length sub-field in the second trigger frame are set to the same value.

In S e-4, when the AP1 transmits the MU-RTS frame on the link 1 (primary link), the AP2 synchronously transmits the MU-RTS frame on the link 2 (non-primary link) (to ensure that an end time of the frame transmitted by the AP1 is aligned with an end time of the frame transmitted by the AP2).

In S e-5, the STA1, after receiving the first trigger frame on the link 1 (primary link), parses the uplink length sub-field in the first trigger frame and sets the length of the subsequently to-be-transmitted PPDU according to the content of the uplink length sub-field. The STA4, after receiving the second trigger frame on the link 2 (non-primary link), parses the uplink length sub-field in the second trigger frame and sets the length of the subsequently to-be-transmitted PPDU according to the content of the uplink length sub-field.

In S e-6, the STA1 and the STA4 may synchronously transmit the uplink PPDU1 and PPDU2 of the same length, after the STA1 receives the SIFS time of the first trigger frame and the STA2 receives the SIFS time of the second trigger frame.

To be noted that, in FIG. 16, the AP1 may transmit the MU-RTS frame on the link 1 (the primary link) to replace the first trigger frame. That is, the uplink length sub-field in the MU-RTS frame transmitted by the AP1 on the link 1 (the primary link) may limit the length of the uplink PPDU that will be subsequently transmitted by the STA1. Similarly, the AP2 in FIG. 16 may transmit the MU-RTS frame on the link 2 (non-primary link) to replace the second trigger frame. That is, the uplink length sub-field in MU-RTS frame transmitted by the AP2 on the link 2 (non-primary link) may limit the length of the uplink PPDU that will be subsequently transmitted by the STA4.

In some embodiments, corresponding to the network architecture shown in FIG. 9 above, as shown in FIG. 17, the backoff counter of the non-AP (STA1) on the primary link reaches zero firstly, and the backoff counter of the AP device (AP2) on the non-primary link reaches zero subsequently. The STA1 (the first non-AP STA) and the STA2 (the second non-AP STA) may transmit uplink data synchronously based on the following S f-1 to S f-7.

In S f-1, the legacy STAT executes the EDCA mechanism on the link 1 (the primary link), the backoff counter is decremented to reach zero, the STAT obtains the transmission opportunity, and the STAT normally transmits the uplink data to the affiliated AP1 in the AP MLD.

In S f-2, the affiliated AP2 in the AP MLD executes the EDCA mechanism on the link 2 (non-primary link), and the backoff counter is decremented to reach zero. In this case, according to the access rules for the AP MLD, since the AP MLD is not the TXOP holder on the primary link, the AP2 maintains the backoff counter as zero according to the multilink channel access rules.

In S f-3, the AP1 and the AP2 are in the same AP MLD, and therefore, the AP1 and the AP2 may interact information with each other. When the STA2, which is associated with the affiliated AP2 in the AP MLD, has uplink data to be transmitted, the AP1 is ready, after receiving the PPDU1 on the link 1 (the primary link), to start performing the synchronous uplink transmission, and the AP2 generates the second information configured to trigger the STA2 to perform the uplink transmission. The second information is sent via the trigger frame (the uplink length sub-field in the trigger frame may limit the length of the uplink PPDU that will be subsequently transmitted by the STA2). The AP1 generates the first information and acknowledges the PPDU1. These information (the first information and the acknowledgement information (i.e., BA1) for PPDU1) are included in the control wrapper frame or in the BA frame. These information may be set in manner 1, manner 2, or manner 3, as follows.

In the manner 1, the first information is added to the A-Control sub-field of the HT control field of the control wrapper frame. The carried frame field of the control wrapper frame is configured to carry any field following the field of the BA1 address 1 to achieve functions of the BA1 (acknowledgement of PPDU1). The first information is included in the A-Control sub-field of the HT control field included in the control wrapper frame and substantially includes the 4-bit Control ID, the 1-bit uplink synchronization indication, the 12-bit uplink length, and 2 or more (no more than 13 bits, since the A-Control length is 30 bits) reserved bits. In the present embodiment, the 4-bit Control ID is set to 0111 (indicating that the subsequent sub-field is configured to indicate information that is to be synchronously uplink transmitted). The 1-bit uplink synchronization indication is set to 1 (the AP MLD requires STA1 to perform synchronous uplink transmission subsequently). The 12-bit uplink length is set to have the same value as the uplink length sub-field carried by the trigger frame transmitted by the AP2 on the link 2 (the non-primary link).

In the manner 2, in the A-Control sub-field of the HT Control field of the control wrapper frame, the TRS control indication information is used as the first information, and the carried frame field of the control wrapper frame is configured to carry any field following the field of the BA1 address 1, and functions of the BA1 (acknowledgement of PPDU1) may be achieved. The A-Control sub-field of the HT control field included in the control wrapper frame is set to a TRS control having the control ID of “0000”, the TRS control is the control field existing in the 802.11ax standard and will not be changed in the present disclosure. The uplink data symbol sub-field included in the TRS control enables the AP MLD to limit the length of the PPDU used by the STA1 to subsequently perform synchronous uplink transmission. In the present example, the value of the uplink data symbol sub-field is set by the AP1, and the value of the uplink length sub-field carried in the trigger frame is set by the AP2. In this way, PPDUs transmitted by two different non-AP MLDs (the STA1 and the STA1) may have the same length.

In the manner 3, the first information is added to the reserved sub-field included in the BA control field of the BA1 frame. Specifically, in the reserved sub-field in the BA control field of the BA1 frame, the first information substantially includes a 1-bit uplink synchronization indication, a 5-bit uplink data symbol, and 2 or more reserved bits. The 1-bit uplink synchronization indication is set to 1. The 5-bit uplink data symbol is set to a value indicating a length being the same as the length of the subsequent PPDU that is indicated by the uplink length sub-field carried by the trigger frame transmitted by the AP2 (that is, the length of the subsequent PPDU that the AP1 instructs, via the uplink data symbol sub-field, the STA1 to transmit is the same as the length of the subsequent PPDU that the AP2 instructs, via the uplink length sub-field, the STA2 to transmit).

In S f-4, when the AP1 replies to the control wrapper frame on the link 1 (the primary link), the AP2 synchronously transmits the trigger frame on the link 2 (the non-primary link) (to ensure that an end time of the AP1 replying to the control wrapper frame is aligned with an end time of the AP2 transmitting the trigger frame).

In S f-5, after the STA1 receives the control wrapper frame on the link 1 (the primary link), the STA1 parses the first information in the A-Control sub-field of the frame. When the first information is set in the manner 1 in S f-3, the STA1 determines whether the uplink synchronization indication sub-field is 1. When the uplink synchronization indication sub-field is 1, it indicates that the AP MLD instructs the STA1 to subsequently perform synchronous uplink transmission. The STA1 further parses the uplink length sub-field and sets the length of the subsequently to-be-transmitted PPDU according to content of the uplink length sub-field. When the first information is set in the manner 2 in S f-3, the STA1 parses the uplink data symbol sub-field in the TRS Control field and sets the length of the subsequently to-be-transmitted PPDU according to the content of the uplink data symbol sub-field. When the STA1 receives the BA1 frame on the link 1 (primary link), the STA1 parses the first information in the reserved sub-field of the BA control sub-field and determines whether the US indication sub-field is 1. When the US indication sub-field is 1, it indicates that the AP MLD instructs the STA1 to subsequently perform the synchronous uplink transmission, the STA1 continues to parse the uplink data symbol sub-field and sets the length of the subsequently to-be-transmitted PPDU according to the content of the uplink data symbol sub-field.

In S f-6, the STA2, after receiving the trigger frame on the link 2 (non-primary link), parses the uplink length sub-field in the trigger frame and sets the length of the subsequently transmitted PPDUs according to the content of the uplink length sub-field.

In S f-7, the STA1 and the STA2 synchronously transmit the uplink PPDU2 and the PPDU3 having the same length, after the STA1 receives the SIFS time of the control wrapper frame and the STA2 receives the SIFS time of the trigger frame.

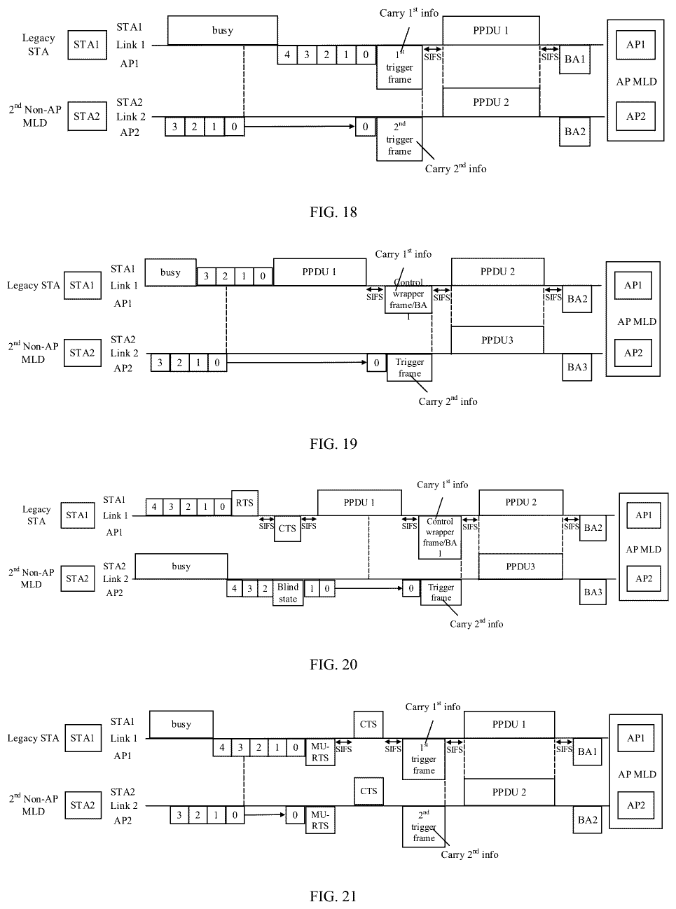

In some embodiments, corresponding to the network architecture shown in FIG. 9 above, as shown in FIG. 18, the backoff counter of the AP device (AP2) on the non-primary link reaches zero firstly, and the backoff counter of the non-AP (STA1) on the primary link reaches zero subsequently. The STA1 (the first non-AP STA) and the STA2 (the second non-AP STA) may transmit uplink data synchronously based on the following S g-1 to S g-6.

In S g-1, the affiliated AP2 in the AP MLD executes the EDCA mechanism on the link 2 (non-primary link), and the backoff counter is decremented to reach zero. In this case, the AP MLD is not the TXOP holder on the primary link, and therefore, the AP2 keeps the backoff counter at zero according to the access rules for the AP MLD.

In S g-2, the affiliated AP1 in the AP MLD executes the EDCA mechanism on the link 1 (the primary link), the backoff counter is decremented to reach zero, and the AP1 obtains the transmission opportunity. In this case, the AP MLD checks whether the affiliated AP2 has a demand of performing downlink transmission on the link 2 (the non-primary link). When the affiliated AP2 has the demand of performing downlink transmission on the link 2, synchronous downlink transmission may be performed in conjunction with the multilink channel access rules of the AP MLD. When the STA1, which is associated with the AP1, or the STA2, which is associated with the AP2, has a large amount of uplink data to be transmitted urgently, the affiliated AP1 and the affiliated AP2 in the AP MLD abandon the downlink transmission opportunity, and uplink synchronous transmission may be triggered through subsequent operations.

In S g-3, the AP1 and the AP2 are in the same AP MLD, and therefore, the AP1 and the AP2 may interact information with each other. The AP1 generates the first information configured to trigger STA1 to perform uplink transmission. The first information is transmitted via the first trigger frame (the uplink length sub-field in the first trigger frame may limit the length of the uplink PPDU that will be subsequently transmitted by the STA1). The AP2 generates the second information configured to trigger the STA2 to perform uplink transmission. The second information is transmitted via the second trigger frame (the uplink length sub-field in the second trigger frame may limit the length of the uplink PPDU that will be subsequently transmitted by the STA2). Specifically, the uplink length sub-field in the first trigger frame and the uplink length sub-field in the second trigger frame are set to the same value.

In S g-4, when the AP1 transmits the first trigger frame on the link 1 (the primary link), the AP2 synchronously transmits the second trigger frame on the link 2 (the non-primary link) (to ensure that an end time of the AP1 transmitting the first trigger frame is aligned with an end time of the AP2 transmitting the second trigger frame).

In S g-5, after the STA1 receives the first trigger frame on the link 1 (the primary link), the STA1 parses the uplink length sub-field in the first trigger frame and sets the length of the subsequently transmitted PPDU according to the content of the uplink length sub-field. After the STA2 receives the second trigger frame on the link 2 (non-primary link), the STA2 parses the uplink length sub-field in the second trigger frame and sets the length of the subsequently transmitted PPDU according to the content of the uplink length sub-field.

In S g-6, the STA1 and the STA2 may synchronously transmit the uplink PPDU1 and the PPDU2 of the same length, after the STA1 receives the SIFS time of the first trigger frame and the STA1 receives the SIFS time of the second trigger frame.

In some embodiments, corresponding to the network architecture shown in FIG. 9 above, as shown in FIG. 19, the backoff counter of the AP device (AP2) on the non-primary link reaches zero firstly, and the backoff counter of the non-AP (STA1) on the primary link reaches zero subsequently. The STA1 (the first non-AP STA) and the STA2 (the second non-AP STA) may synchronously transmit uplink data based on the following S h-1 to S h-7.

In S h-1, the affiliated AP2 in the AP MLD executes the EDCA mechanism on the link 2 (non-primary link), and the backoff counter is decremented to reach zero. In this case, according to the access rules of the AP MLD, the AP MLD is not the TXOP holder on the primary link, and therefore, the AP2 keeps the backoff counter at zero according to the multilink channel access rules.

In S h-2, the legacy STA1 executes the EDCA mechanism on the link 1 (the primary link), the backoff counter is decremented to reach zero, the STA1 obtains the transmission opportunity, and the STA1 normally transmits uplink data to the affiliated AP1 in the mobile AP MLD.

Subsequent operations S h-3 to S h-7 are the same as the operations S f-3 to S f-7, and will not be repeated herein.

In some embodiments, corresponding to the network architecture shown in FIG. 9 above, as shown in FIG. 20, in the RTS and CTS exchanging scenario, the backoff counter of the non-AP (STA1) on the primary link reaches zero firstly, and the backoff counter of the AP device (AP2) on the non-primary link reaches zero subsequently. The STA1 (the first non-AP STA) and the STA2 (the second non-AP STA) may synchronously transmit uplink data based on the following S i-1 to S i-7.

In S i-1, the legacy STA1 executes the EDCA mechanism on the link 1 (the primary link), the backoff counter is decremented to reach zero, the STA1 obtains the transmission opportunity, and the STA1 normally transmits uplink data to the affiliated AP1 in the mobile AP MLD, where the RTS and CTS exchanging process is included.

In S i-2, the affiliated AP2 in the AP MLD executes the EDCA mechanism on the link 2 (non-primary link). When the AP1 transmits the CTS on the link 1 (primary link), due to the NSTR characteristic of the AP MLD, while the CTS is being transmitted, the AP2 will be in a blind state, and the backoff counter stops being decremented. After the AP1 finishes transmitting the CTS, the AP2 exits the blind state, and the backoff counter continues to be decremented. When the backoff counter is decremented to reach zero, according to the access rules of the AP MLD, the AP MLD is not the TXOP holder on the primary link, and therefore, the AP2 keeps the backoff counter at zero according to the multilink channel access rules.

The subsequent operations S i-3 to S i-7 are the same as the operations S f-3 to S f-7, and will not be repeated herein.

In some embodiments, corresponding to the network architecture shown in FIG. 9 above, as shown in FIG. 21, in the RTS and CTS exchanging scenario, the backoff counter of the AP device (AP2) on the non-primary link reaches zero firstly, and the backoff counter of the non-AP (STA1) on the primary link reaches zero subsequently. The STA1 (the first non-AP STA) and the STA2 (the second non-AP STA) synchronously transmit uplink data based on the following S j-1 to S j-6.

In S j-1, the affiliated AP2 in the AP MLD executes the EDCA mechanism on the link 2 (non-primary link), and the backoff counter is decremented to reach zero. In this case, according to the access rules of the AP MLD, the AP MLD is not the TXOP holder on the primary link, and therefore, the AP2 keeps the backoff counter at zero according to the multilink channel access rules.

In S j-2, the affiliated AP1 in the AP MLD executes the EDCA mechanism on the link 1 (the primary link), the backoff counter is decremented to reach zero, and the affiliated AP1 obtains the transmission opportunity. In this case, the AP MLD checks whether the affiliated AP2 has a demand of performing downlink transmission on the link 2 (the non-primary link). When the affiliated AP2 has the demand of performing downlink transmission on the link 2, synchronous downlink transmission may be performed in conjunction with the multilink channel access rules of the AP MLD. When the STA1, which is associated with the AP1, and the STA2, which is associated with the AP2, have a large amount of uplink data to be transmitted urgently, the affiliated AP1 and AP2 in the AP MLD abandon the downlink transmission opportunity, and the uplink synchronous transmission may be triggered through subsequent operations.

In S j-3, the AP1 and the AP2 are in the same AP MLD, and therefore, the AP1 and the AP2 may interact information with each other. The AP1 generates the first information configured to trigger STA1 to perform uplink transmission. The first information is transmitted via the first trigger frame (the uplink length sub-field in the first trigger frame may limit the length of the uplink PPDU that will be subsequently transmitted by the STA1). The AP2 generates the second information configured to trigger the STA2 to perform uplink transmission. The second information is transmitted via the second trigger frame (the uplink length sub-field in the second trigger frame may limit the length of the uplink PPDU that will be subsequently transmitted by the STA2). Specifically, the uplink length sub-field in the first trigger frame and the uplink length sub-field in the second trigger frame are set to the same value.

In S j-4, when the AP1 transmits the MU-RTS frame on the link 1 (primary link), the AP2 synchronously transmits the MU-RTS frame on the link 2 (non-primary link) (to ensure that an end time of the AP1 transmitting the MU-RTS frame is aligned with an end time of the AP2 transmitting the MU-RTS frame). Subsequently, when the AP1 transmits the first trigger frame on the link 1 (primary link), the AP2 synchronously transmits the second trigger frame on the link 2 (non-primary link) (to ensure that an end time of the AP1 transmitting the first trigger frame is aligned with an end time of the AP2 transmitting the second trigger frame).

In S j-5, the STA1, after receiving the first trigger frame on the link 1 (primary link), parses the uplink length sub-field in the first trigger frame and sets the length of the subsequently transmitted PPDU according to the content of the uplink length sub-field. The STA2, after receiving the second trigger frame on the link 2 (non-primary link), parses the uplink length sub-field in the second trigger frame and sets the length of the subsequently transmitted PPDU according to the content of the uplink length sub-field.

In S j-6, the STA1 and the STA2 synchronously transmit the uplink PPDU1 and the PPDU2 of the same length, after the STA1 receives the SIFS time of the first trigger frame and the STA2 receives the SIFS time of the second trigger frame.

Therefore, in embodiments of the present disclosure, the AP MLD shares the TXOP, which is obtained by the AP MLD on the non-primary link, to the second non-AP STA and indicates the lengths of the uplink PPDUs synchronously transmitted on the primary link and on the non-primary link. The uplink access restriction is relaxed. The success rate of uplink synchronous transmission in the AP MLD is improved, without affecting the transmission quality of the single-link device on the primary link, and a transmission service having high throughput is provided. A plurality of independent non-AP STAs of various non-AP MLDs may be triggered to perform synchronous uplink transmission. Further, modifications are provided for the access rules for the mobile AP MLDs in the 802.11be standard.

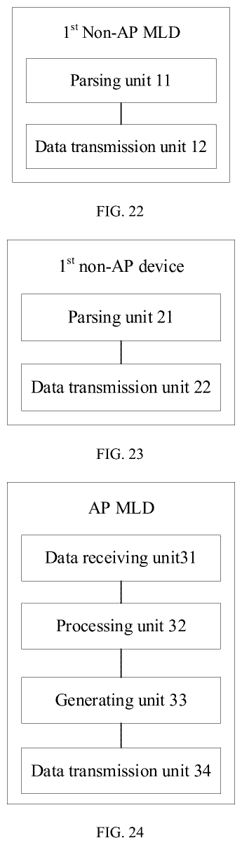

In some embodiments, as shown in FIG. 22, the first non-AP MLD may include a parsing unit 11 and a data transmitting unit 12.

The parsing unit 11, after receiving the control wrapper frame or the trigger frame, parses the first information sent from the AP MLD. When the value of the received control ID is “0111”, it is determined determines whether the uplink synchronization indication sub-field is 1. When the uplink synchronization indication sub-field is 1, it means that the AP MLD instructs the first non-AP MLD to subsequently perform the synchronous uplink transmission. The parsing unit 11 further parses the uplink length sub-field and sets the length of the PPDU that is to be transmitted subsequently based on the content of the uplink length sub-field. When the value of the received control ID is “0000”, it means that the AP MLD instructs the first non-AP MLD to subsequently perform the synchronous uplink transmission. The parsing unit 11 further parses the uplink data symbol sub-field in the TRS control field and sets the length of the PPDU that is to be transmitted subsequently based on the content of the uplink data symbol sub-field.

The data transmitting unit 12 is configured to transmit the subsequent uplink PPDU based on the first information sent by the AP MLD. Specifically, the data transmitting unit 12 transmits, after receiving the SIFS time of the control wrapper frame or the SIFS time of the trigger frame, the uplink PPDU having the length that has been limited.

In some embodiments, as shown in FIG. 23, the first non-AP STA (legacy non-AP) may include a parsing unit 21 and a data transmitting unit 22.

The parsing unit 21, after receiving the control wrapper frame or the trigger frame, parses the first information sent from the AP MLD. When the value of the received control ID is “0111”, it is determined determines whether the uplink synchronization indication sub-field is 1. When the uplink synchronization indication sub-field is 1, it means that the AP MLD instructs the first non-AP STA to subsequently perform the synchronous uplink transmission. The parsing unit 21 further parses the uplink length sub-field and sets the length of the PPDU that is to be transmitted subsequently based on the content of the uplink length sub-field. When the value of the received control ID is “0000”, it means that the AP MLD instructs the first non-AP STA to subsequently perform the synchronous uplink transmission. The parsing unit 21 further parses the uplink data symbol sub-field in the TRS control field and sets the length of the PPDU that is to be transmitted subsequently based on the content of the uplink data symbol sub-field.

The data transmitting unit 22 is configured to transmit the subsequent uplink PPDU based on the first information sent by the AP MLD. Specifically, the data transmitting unit 22 transmits, after receiving the SIFS time of the control wrapper frame or the SIFS time of the trigger frame, the uplink PPDU having the length that has been limited.

In some embodiments, as shown in FIG. 24, the AP MLD may include a data receiving unit 31, a processing unit 32, a generating unit 33, and a data transmitting unit 34.

The data receiving unit 31 is configured to receive uplink data from a non-AP multilink device or a single-link device.

The processing unit 32 is configured to execute the EDCA mechanism on the non-primary link; and check whether the AP MLD is the TXOP holder on the primary link in response to the backoff counter being decremented to reach zero. When the AP MLD is not the TXOP holder on the primary link, the backoff counter is maintained at zero based on the multilink channel access rules.

The generating unit 33 is configured to generate the control wrapper frame on the primary link to achieve acknowledgement of the PPDU and to carry information of indicating synchronous uplink transmission. The carried frame field of the control wrapper frame is configured to carry any field following the field of the BA1 address 1 to achieve functions of the BA1 (acknowledgement of the PPDU). The first information is set in two ways. In one way, the first information is set by including 4 bits of the control ID, 1 bit of uplink synchronization indication, and 12 bits of the uplink length, into the A-Control sub-field of the HT control field of the control wrapper frame. In another way, the first information is set by using an existing TRS control indication information in the A-Control sub-field of the HT control field, and the TRS control indication information includes the uplink data symbol sub-field.

The generating unit 33 is further configured to generate the trigger frame on the primary link or the non-primary link. The uplink length sub-field in the trigger frame may limit the length of the uplink PPDU that is subsequently transmitted by the non-AP.

The data transmitting unit 34 is configured to enable the AP MLD to synchronously transmit the control wrapper frame on the primary link and transmit the trigger frame on the non-primary link; or to enable the AP MLD to synchronously transmit trigger frames on the primary link and on the non-primary link to trigger two independent sites to perform synchronous uplink transmission.

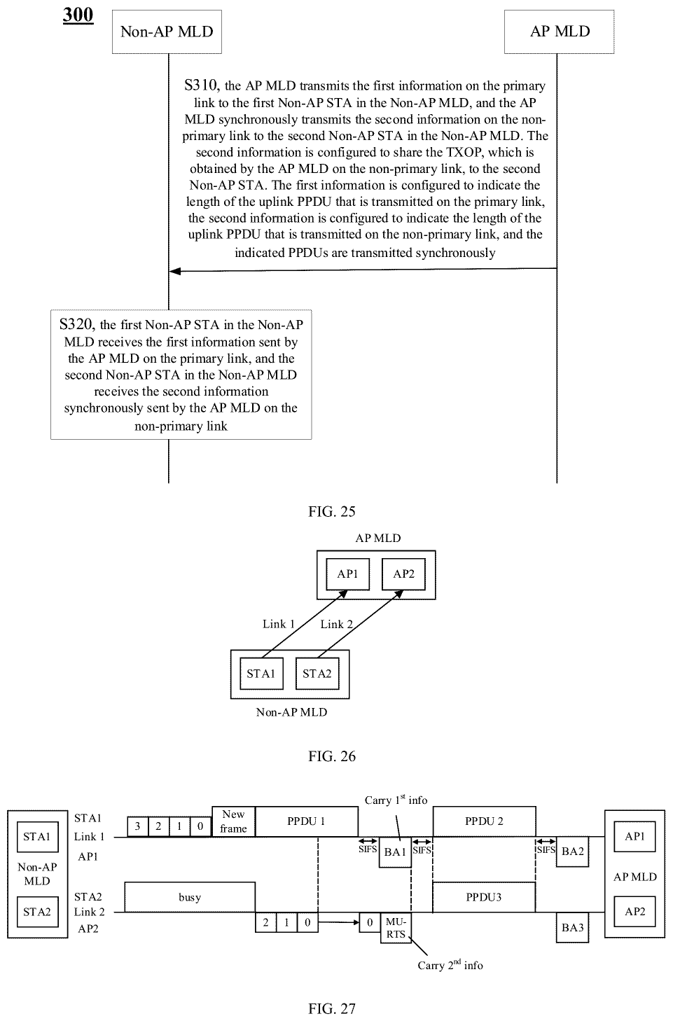

FIG. 25 is a flow chart showing interaction of a wireless communication 300 method according to an embodiment of the present disclosure. As shown in FIG. 25, the wireless communication 300 includes at least some of the following operations.

In S310, the AP MLD transmits the first information on the primary link to the first non-AP STA in the non-AP MLD, and the AP MLD synchronously transmits the second information on the non-primary link to the second non-AP STA in the non-AP MLD. The second information is configured to share the TXOP, which is obtained by the AP MLD on the non-primary link, to the second non-AP STA. The first information is configured to indicate the length of the uplink PPDU that is transmitted on the primary link, the second information is configured to indicate the length of the uplink PPDU that is transmitted on the non-primary link, and the indicated PPDUs are transmitted synchronously.

In S320, the first non-AP STA in the non-AP MLD receives the first information sent by the AP MLD on the primary link, and the second non-AP STA in the non-AP MLD receives the second information synchronously sent by the AP MLD on the non-primary link.

In some embodiments, the first non-AP STA in the non-AP MLD transmits the uplink data on the primary link based on the first information. The second non-AP STA in the non-AP MLD transmits the uplink data on the non-primary link based on the second information.

The first information indicates the length of the uplink PPDU transmitted on the primary link, and the second information indicates the length of the uplink PPDU that is transmitted on the non-primary link synchronously with the uplink PPDU transmitted on the primary link. Therefore, the uplink data transmission, which is performed by the first non-AP STA in the non-AP MLD based on the first information, and the uplink data transmission, which is performed by the second non-AP STA in the non-AP MLD based on the second information, are performed synchronously.

In some embodiments, the AP MLD includes at least one NSTR link pair, one link pair of the at least one NSTR link pair includes the primary link and the non-primary link.

In some embodiments, the AP MLD is the mobile AP MLD. The following embodiments are illustrated by taking the AP MLD as the mobile AP MLD, i.e., the AP MLD and the mobile AP MLD hereinafter are different names for the same device.

Specifically, the non-AP MLD and the mobile AP MLD have the NSTR link pair. That is, the mobile AP MLD and the non-AP MLD associated with the mobile AP MLD cannot receive data on one link of the NSTR link pair and synchronously transmit data on the other link of the NSTR link pair. Alternatively, the mobile AP MLD and the non-AP MLD associated with the mobile AP MLD cannot transmit data on one link of the NSTR link pair and synchronously receive data on the other link of the NSTR link pair.

The embodiments of the present disclosure only exemplify a case where the mobile AP MLD has one primary link and one non-primary link. Of course, the present disclosure may also be applied to a case where the mobile AP MLD has a plurality of primary links and/or a plurality of non-primary links.

In some embodiments, the non-AP MLD may include the NSTR link pair, and may include the STR link pair.

To be noted that the NSTR is generally for a pair of links, such as 5 GHz and 6 GHz. When the NSTR link pair is present in the mobile AP MLD, the mobile AP MLD cannot simultaneously transmit data on one link of the link pair and receive data on the other link of the link pair. When a 2.4 GHz and 6 GHz link pair is present in the mobile AP MLD, the mobile AP MLD may transmit data on one link of the link pair and simultaneously receive data on the other link of the link pair. That is, the mobile AP MLD cannot transmit data and receive data at the same time only when the mobile AP MLD is operating on the NSTR link pair. The NSTR is not a property of the device, but a property of the link.

Further, to be noted that, whether a multilink device can simultaneously transmit data and receive data on an NSTR link pair is substantially dependent on performance of the device. For a normal AP MLD device, even if the normal AP MLD device is operating on the NSTR link pair, as long as the AP MLD can solve the problem of in-device coexistence (IDC) interference, the normal AP MLD device may simultaneously transmit data and receive data on the NSTR link pair. However, the mobile AP MLD device does not have a capability of solving the problem of IDC interference, and therefore, the mobile AP MLD cannot simultaneously transmit data and receive data on the NSTR link pair.

In some embodiment, the network architecture used in the present embodiment may be as shown in FIG. 26, AP MLD devices have two affiliated APs, the AP1 and the AP2. The AP1 is associated, on the link 1 (the primary link), with the STA1 in the non-AP MLD. The AP2 is associated, on the link 2 (the non-primary link), with the STA2 in the non-AP MLD. The link 1 and the link 2 form one NSTR link pair. In the present embodiment, the STA1 (i.e., the first non-AP STA) in the non-AP MLD performs uplink transmission on the link 1, and synchronously, the STA2 (i.e., the second non-AP STA) in the non-AP MLD performs uplink transmission on the link 2.

In some embodiments, the first non-AP STA in the non-AP MLD transmits the first indication information to the AP MLD on the primary link, and the first indication information is configured to instruct the AP MLD to assist the second non-AP STA in listening to the non-primary link.

In some embodiments, the AP MLD assists the second non-AP STA in listening to the non-primary link based on the first indication information.

In some embodiments, the backoff counter maintained by the first non-AP STA is firstly decremented to reach zero, and the backoff counter maintained by the AP device on the non-primary link in the AP MLD is subsequently decremented to reach zero. The AP device on the non-primary link in the AP MLD keeps the backoff counter, which is maintained by the AP device, at zero after the backoff counter maintained by the AP device on the non-primary link in the AP MLD is decremented to reach zero and before the second information is transmitted on the non-primary link in the AP MLD.

In some embodiments, the backoff counter maintained by the AP device on the non-primary link in the AP MLD is firstly decremented to reach zero, and the backoff counter maintained by the first non-AP STA is decremented to reach zero subsequently. The AP device on the non-primary link in the AP MLD keeps the backoff counter, which is maintained by the AP device, at zero after the backoff counter maintained by the AP device on the non-primary link in the AP MLD is decremented to reach zero and before the second information is transmitted on the non-primary link in the AP MLD.

In some embodiments, the first indication information is included in a first frame, and the first frame is one of:

a control wrapper frame, a management frame, and a data frame.

In some embodiments, the backoff counter maintained by the AP device on the non-primary link in the AP MLD is firstly decremented to reach zero, and the backoff counter maintained by the first non-AP STA is subsequently decremented to reach zero. The AP device on the non-primary link in the AP MLD keeps the backoff counter, which is maintained by the AP device, at zero after the backoff counter maintained by the AP device on the non-primary link in the AP MLD is decremented to reach zero and before the second information is transmitted on the non-primary link in the AP MLD.

In some embodiments, the backoff counter maintained by the first non-AP STA is firstly decremented to reach zero, and the backoff counter maintained by the AP device on the non-primary link in the AP MLD is subsequently decremented to reach zero. The AP device on the non-primary link in the AP MLD keeps the backoff counter, which is maintained by the AP device, at zero after the backoff counter maintained by the AP device on the non-primary link in the AP MLD is decremented to reach zero and before the second information is transmitted on the non-primary link in the AP MLD.

In some embodiments, the backoff counter maintained by the AP device on the non-primary link in the AP MLD stops being decremented while the AP device on the primary link in the AP MLD is transmitting the CTS frame. Further, after the AP device on the primary link in the AP MLD finishes transmitting the CTS frame, the backoff counter maintained by the AP device on the non-primary link in the AP MLD continues to be decremented.

In some embodiments, the backoff counter maintained by the AP device on the non-primary link in the AP MLD is firstly decremented to reach zero, and the backoff counter maintained by the AP device on the primary link in the AP MLD is subsequently decremented to reach zero. The AP device on the primary link in the AP MLD keeps the backoff counter, which is maintained by the AP device, at zero after the backoff counter maintained by the AP device on the non-primary link in the AP MLD is decremented to reach zero and before the second information is transmitted on the non-primary link in the AP MLD.

In some embodiments, the first information is included in a second frame, and the second frame is one of the following:

the trigger frame, the MU-RTS frame, and the BA frame.

In some embodiments, the second information is included in a third frame, and the third frame is one of:

the trigger frame and the MU-RTS frame.

In some embodiments, the non-AP MLD determines the primary link and the non-primary link based on instructions from the AP MLD while the non-AP MLD is establishing multilink connection with the AP MLD.

In some embodiments, corresponding to the network architecture shown in FIG. 26 above, as shown in FIG. 27, the backoff counter of the non-AP (STA1) on the primary link reaches zero firstly, and the backoff counter of the non-AP (STA2) on the non-primary link reaches zero subsequently. The STA1 (the first non-AP STA) and the STA2 (the second non-AP STA) may transmit uplink data synchronously based on the following S k-1 to S k-5.

In S k-1, the affiliated non-AP STA1 in the non-AP MLD executes the EDCA mechanism on the link 1 (the primary link), the backoff counter is decremented to reach zero, and the affiliated non-AP STA1 obtains the transmission opportunity. In this case, the non-AP MLD checks whether the affiliated non-AP STA2 has a demand of performing uplink transmission on the link 2 (the non-primary link) and whether the backoff counter is decremented to reach zero. When the affiliated non-AP STA2 has the demand of performing uplink transmission on the link 2 but the backoff counter is not decremented to reach zero, the STA1 transmits uplink data to AP1 in the AP MLD normally. Since the STA2 may enter the blind state and cannot be decremented normally while the STA1 is transmitting data to the AP1, the AP2 needs to assist in obtaining the transmission opportunity and to transfer the TXOP to the STA2. Therefore, before PPDU1 is transmitted, the STA1 needs to transmit the first indication information to the AP 1, the AP1 enables, after receiving the first indication information, the AP2 to assist in listening to the link 2. The first indication information is included in a new frame. For example, the new frame is a control wrapper frame or a management frame or a data frame.

In S k-2, after the attached AP1 in the AP MLD receives the first indication information sent by the STA1 on the link 1 (the primary link), the AP2 executes the EDCA mechanism on the link 2 (the non-primary link), and the backoff counter is decremented to reach zero. At this moment, according to the access rules of the AP MLD, the AP MLD is not the TXOP holder on the primary link, and therefore, the AP2 maintains the backoff counter at zero according to the multilink channel access rules.

In S k-3, the AP1 and the AP2 are in the same AP MLD. Therefore, the AP1 and the AP2 may interact information with each other. The AP1 is ready to start, after receiving the PPDU1 on the link 1 (the primary link), the synchronous uplink transmission (generates the first information). The AP2 generates the MU-RTS frame (carrying the second information) that is used to trigger the STA2 to perform the uplink transmission.

In S k-4, when the AP1 replies the BA1 (carrying the first information) on the link 1 (primary link), the AP2 synchronously transmits the MU-RTS (carrying the second information) on the link 2 (non-primary link) (to ensure that an end time of the AP1 replying the BA1 is aligned to an end time of the AP2 transmitting the MU-RTS).

In S k-5, after the STA2 receives the SIFS time of the MU-RTS, the STA1 transmits the PPDU2, and the STA2 synchronously transmits the PPDU3, and the PPDU2 and the PPDU3 have the same length.

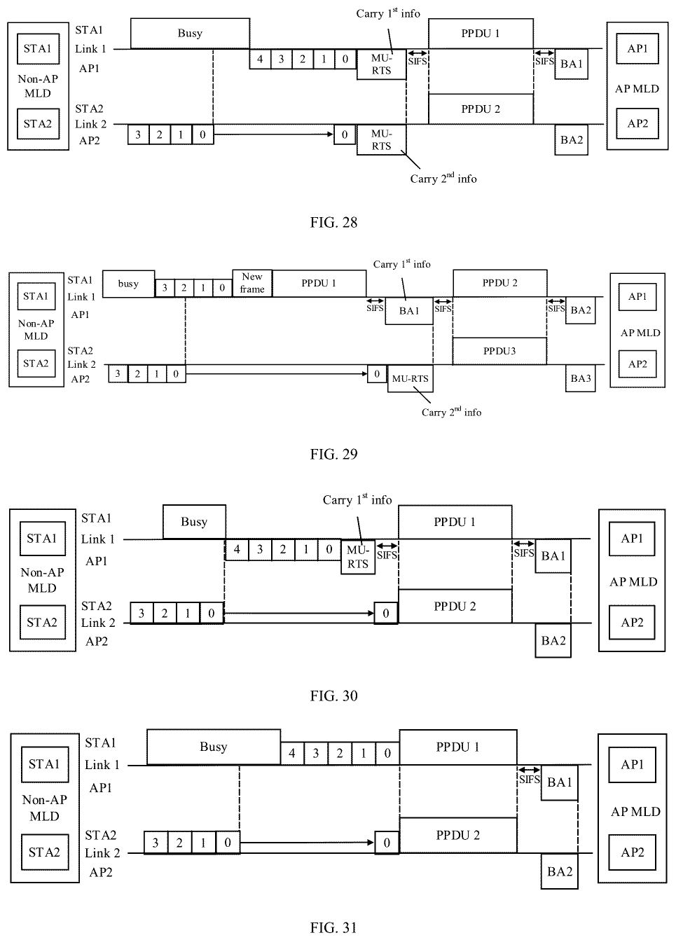

In some embodiments, corresponding to the network architecture shown in FIG. 26 above, as shown in FIG. 28, the backoff counter of the non-AP (STA2) on the non-primary link reaches zero firstly, and the backoff counter of the non-AP (STA1) on the primary link reaches zero subsequently. The STA1 (the first non-AP STA) and the STA2 (the second non-AP STA) may transmit uplink data synchronously based on the following S 1-1 to S 1-5.

In S 1-1, the affiliated AP2 in the AP MLD executes the EDCA mechanism on the link 2 (the non-primary link), and the backoff counter is decremented to reach zero. In this case, according to the access rules of the AP MLD, the AP MLD is not the TXOP holder on the primary link, the AP2 keeps the backoff counter at zero according to the multilink channel access rules.

In S 1-2, the affiliated AP1 in the AP MLD executes the EDCA mechanism on the link 1 (the primary link), the backoff counter is decremented to reach zero, and the affiliated AP1 obtains the transmission opportunity. In this case, the AP MLD checks whether the affiliated AP2 has a demand of performing downlink transmission on the link 2 (the non-primary link). When the affiliated AP2 has the demand of performing downlink transmission on the link 2, the synchronous downlink transmission is performed in conjunction with the multilink channel access rule of the AP MLD. When the STA1, which is associated with the AP1, or the STA2, which is associated with the AP2, has a large amount of uplink data to be transmitted urgently, the affiliated AP1 and AP2 in the AP MLD abandon the downlink transmission opportunity, and uplink synchronous transmission may be triggered by a subsequent operation.

In S 1-3, the AP1 and the AP2 are in the same AP MLD, and therefore, the AP1 and the AP2 may interact information with each other. The AP1 generates the MU-RTS (carrying the first information) configured to trigger the STA1 to perform uplink transmission. The AP2 generates the MU-RTS (carrying the second information) configured to trigger STA2 to perform uplink transmission.

In S 1-4, when the AP1 transmits the MU-RTS on the link 1 (the primary link), the AP2 synchronously transmits the MU-RTS on the link 2 (the non-primary link) (to ensure that an end time of the AP1 transmitting the MU-RTS is aligned to an end time of the AP2 transmitting the MU-RTS).

In S 1-5, after the STA1 and the STA2 receive the SIFS time of the MU-RTS, the STA1 transmits the uplink PPDU1, and the STA2 synchronously transmits the uplink PPDU2, and the PPDU1 and the PPDU2 have the same length.

In some embodiments, corresponding to the network architecture shown in FIG. 26 above, as shown in FIG. 29, the backoff counter of the non-AP (STA2) on the non-primary link reaches zero firstly, and the backoff counter of the non-AP (STA1) on the primary link reaches zero subsequently. The STA1 (the first non-AP STA) and the STA2 (the second non-AP STA) may transmit uplink data synchronously based on the following S m-1 to S m-5.

In S m-1, the affiliated AP2 in the AP MLD executes the EDCA mechanism on the link 2 (non-primary link), and the backoff counter is decremented to reach zero. At this moment, according to the access rules of the AP MLD, the AP MLD is not the TXOP holder on the primary link, and therefore, the AP2 keeps the backoff counter at zero according to the multilink channel access rules.

In S m-2, the affiliated non-AP STA1 in the non-AP MLD executes the EDCA mechanism on the link 1 (the primary link), the backoff counter is decremented to reach zero, and the affiliated non-AP STA1 obtains the transmission opportunity. In this case, the non-AP MLD checks whether the affiliated non-AP STA2 has a demand of performing uplink transmission on the link 2 (the non-primary link) and whether the backoff counter is decremented to reach zero. When the affiliated non-AP STA2 has the demand of performing uplink transmission on the link 2 but the backoff counter is not decremented to reach zero, the STA1 transmits uplink data to AP1 in the AP MLD normally. Since the STA2 may enter the blind state and cannot be backed off normally while the STA1 is transmitting data to the AP1, the AP2 needs to assist in obtaining the transmission opportunity and to transfer the TXOP to the STA2. Therefore, before PPDU1 is transmitted, the STA1 needs to transmit the first indication information to the AP1, the AP1 enables, after receiving the first indication information, the AP2 to assist in listening to the link 2. The first indication information is included in the new frame.

The subsequent operations S m-3 to S m-5 are the same as the operations S k-3 to S k-5, and will not be repeated herein.

In some embodiments, corresponding to the network architecture shown in FIG. 26 above, as shown in FIG. 30, the backoff counter of the non-AP (STA2) on the non-primary link reaches zero firstly, and the backoff counter of the non-AP (STA1) on the primary link reaches zero subsequently. The STA1 (the first non-AP STA) and the STA2 (the second non-AP STA) may transmit uplink data synchronously based on the following S n-1 to S n-4.

In S n-1, the affiliated non-AP STA2 in non-AP MLD executes the EDCA mechanism on the link 2 (non-primary link), the backoff counter is decremented to reach zero, and the affiliated non-AP STA2 obtains the transmission opportunity. Since the non-AP MLD is associated with the AP MLD, and according to the access rule of the AP MLD, the affiliated STA1 of the non-AP MLD is not the TXOP holder on the primary link. Therefore, the STA2 maintains the backoff counter at zero according to the access rules of the AP MLD.

In S n-2, the affiliated AP1 in the AP MLD executes the EDCA mechanism on the link 1 (the primary link), the backoff counter is decremented to reach zero, and the affiliated AP1 obtains the transmission opportunity. When the STA1 associated with AP1 has a large amount of urgent uplink data to be transmitted, the affiliated AP1 in the AP MLD abandons the downlink transmission opportunity, and the STA1 is triggered to perform the uplink transmission by a subsequent operation.

In S n-3, the AP1 generates the MU-RTS (carrying the first information) that is configured to trigger the STA1 to perform uplink transmission and transmits the MU-RTS to the STA1 on the link 1 (primary link).

In S n-4, after the STA1 receive the SIFS time of the MU-RTS, the STA1 transmits the uplink PPDU1, and the STA2 synchronously transmits the uplink PPDU2, and the PPDU1 and the PPDU2 have the same length.

In some embodiments, corresponding to the network architecture shown in FIG. 26 above, as shown in FIG. 31, the backoff counter of the non-AP (STA2) on the non-primary link reaches zero firstly, and the backoff counter of the non-AP (STA1) on the primary link reaches zero subsequently. The STA1 (the first non-AP STA) and the STA2 (the second non-AP STA) may transmit uplink data synchronously based on the following S o-1 to S o-3.

In S o-1, the affiliated non-AP STA2 in the non-AP MLD performs the EDCA mechanism on the link 2 (non-primary link), the backoff counter is decremented to reach zero, and the non-AP STA2 obtains the transmission opportunity. Since the non-AP MLD is associated with the AP MLD, according to the access rule of the AP MLD, the affiliated STA1 of the non-AP MLD is not the TXOP holder on the primary link. Therefore, the STA2 maintains the backoff counter at zero according to the access rule of AP MLD.

In S o-2, the affiliated non-AP STA1 in the non-AP MLD executes the EDCA mechanism on the link 1 (the primary link), the backoff counter is decremented to reach zero, and the non-AP STA1 obtains the transmission opportunity. At this moment, the non-AP MLD checks whether the affiliated non-AP STA2 has a demand of performing uplink transmission on the link 2 (the non-primary link) and whether the backoff counter has reached zero. When the affiliated non-AP STA2 has the demand of performing uplink transmission on the link 2 and the backoff counter has reached zero, uplink synchronous transmission within the same multilink device is performed based on the multilink channel access rule.

In S o-3, the STA1 transmits the uplink PPDU1 on the link 1, the STA2 synchronously transmits the uplink PPDU2 on the link 2, and the PPDU1 and the PPDU2 have the same length, ensuring an end time of the STA1 transmitting the uplink PPDU1 to be aligned with an end time of the STA2 transmitting the uplink PPDU2.

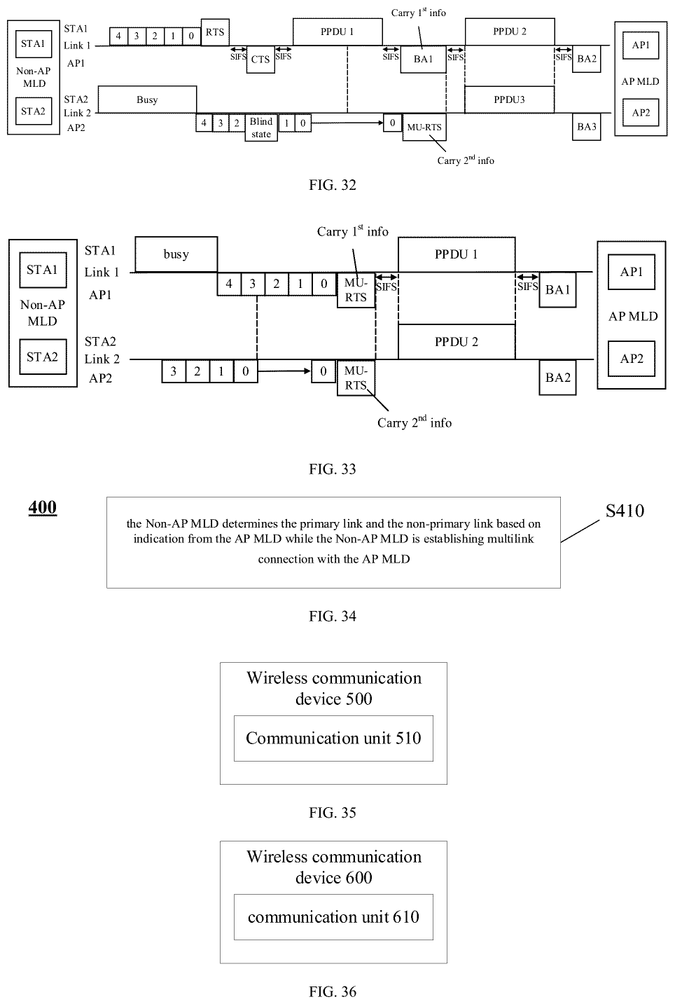

In some embodiments, corresponding to the network architecture shown in FIG. 26 above, as shown in FIG. 32, considering the RTS and CTS exchanging scenario, the backoff counter of the non-AP (STA1) on the primary link reaches zero firstly, and the backoff counter of the non-AP (STA2) on the non-primary link reaches zero subsequently. The STA1 (the first non-AP STA) and the STA2 (the second non-AP STA) may transmit uplink data synchronously based on the following S p-1 to S p-3.

In S p-1, the affiliated non-AP STA1 in the non-AP MLD executes the EDCA mechanism on the link 1 (the primary link), the backoff counter is decremented to reach zero, and the affiliated non-AP STA1 obtains the transmission opportunity. At this moment, the non-AP MLD checks whether the affiliated non-AP STA2 has a demand of performing uplink transmission on the link 2 (the non-primary link) and whether the backoff counter has been decremented to reach zero. When the affiliated non-AP STA2 has the demand of performing uplink transmission on the link 2 and the backoff counter has been decremented to reach zero, uplink synchronous transmission within the same multilink device is performed according to the multilink channel access rules. When the affiliated non-AP STA2 does not have the demand of performing uplink transmission on the link 2 or the backoff counter has not been decremented to reach zero, the STA1 transmits uplink data normally to the affiliated AP1 in the AP MLD, and the uplink data includes the RTS and CTS exchanging process.

In S p-2, the affiliated AP2 in the AP MLD executes the EDCA mechanism on the link 2 (non-primary link). In response to the AP1 transmitting the CTS on the link 1 (primary link), due to the NSTR characteristics of the link 1 and the link 2, while the CTS is being transmitted, the AP2 may be in the blind state, and the backoff counter stops being backed off After AP1 finishes transmitting the CTS, the AP2 exits from the blind state, and the backoff counter continues to be decremented. When the backoff counter is decremented to reach zero, the AP1 in the AP MLD is receiving data on the link 1, and therefore, the AP2 cannot transmit downlink data due to the NSTR characteristics of the link 1 and the link 2, and the AP2 keeps the backoff counter at zero according to the multilink channel access rule.

The subsequent S p-3-S p-5 are the same as the operations S k-3 to S k-5, and will not be repeated herein.

In some embodiments, corresponding to the network architecture shown in FIG. 26 above, as shown in FIG. 33, considering the RTS and CTS exchanging scenario, the backoff counter of the non-AP (STA2) on the non-primary link reaches zero firstly, and the backoff counter of the non-AP (STA1) on the primary link reaches zero subsequently. The STA1 (the first non-AP STA) and the STA2 (the second non-AP STA) may transmit uplink data synchronously based on the following S q-1 to S q-3.

In S q-1, the affiliated AP2 in the AP MLD executes the EDCA mechanism on the link 2 (non-primary link), and the backoff counter is decremented to reach zero. At this moment, according to the access rules of the AP MLD, the AP MLD is not the TXOP holder on the primary link, and therefore, the AP2 keeps the backoff counter at zero according to the multilink channel access rules.

In S q-2, the affiliated AP1 in the AP MLD executes the EDCA mechanism on the link 1 (the primary link), the backoff counter is decremented to reach zero, and the affiliated AP1 obtains the transmission opportunity. At this moment, the AP MLD checks whether the affiliated AP2 has a demand of performing downlink transmission on the link 2 (the non-primary link). When the affiliated AP2 has the demand of performing downlink transmission on the link 2, synchronous downlink transmission may be performed in conjunction with the multilink channel access rule of the AP MLD. Subsequent operations are not defined in the present disclosure. When the STA1 associated with AP1 or the STA2 associated with AP2 has a large amount of urgent uplink data to be transmitted, the affiliated AP1 and the affiliated AP2 in the AP MLD abandon the downlink transmission opportunity, and uplink synchronous transmission may be triggered by subsequent operations.

In S q-3, the AP1 and the AP2 are in the same AP MLD, and therefore, the AP1 and the AP2 may interact information with each other. The AP1 generates the MU-RTS (carrying the first information) configured to trigger STA1 to perform uplink transmission. The AP2 generates the MU-RTS (carrying the second information) configured to trigger the STA2 to perform uplink transmission.

In S q-4, while the AP1 is transmitting the MU-RTS on the link 1 (the primary link), the AP2 synchronously transmits the MU-RTS on the link 2 (the non-primary link) (to ensure that an end time of the AP1 transmitting the MU-RTS is aligned with an end time of the AP2 transmitting the MU-RTS).

In S q-5, after receiving the SIFS time of the MU-RTS, the STA1 transmits the uplink PPDU1, and the STA2 synchronously transmits the uplink PPDU2, the PPDU1 and the PPDU2 have the same length.

Therefore, in the embodiments of the present disclosure, the AP MLD shares the TXOP, which is obtained on the non-primary link, to the second non-AP STA and indicates lengths of the uplink PPDUs that are synchronously transmitted on the primary link and the non-primary link respectively. The uplink access restriction is relaxed. The success rate of uplink synchronous transmission in the AP MLD is improved, without affecting the transmission quality of the single-link device on the primary link, and a transmission service having high throughput is provided. A plurality of independent non-AP STAs of various non-AP MLDs may be triggered to perform synchronous uplink transmission. Further, modifications are provided for the access rules for the mobile AP MLDs in the 802.11be standard.

FIG. 34 is a flow chart of a wireless communication method 400 according to an embodiment of the present disclosure. As shown in FIG. 34, the wireless communication method 400 includes at least some of the following.

In S410, the non-AP MLD determines the primary link and the non-primary link based on indication from the AP MLD while the non-AP MLD is establishing multilink connection with the AP MLD.

In some embodiments, the AP MLD includes at least one NSTR link pair, one link pair of the at least one NSTR link pair includes the primary link and the non-primary link.

In some embodiments, the AP MLD is the mobile AP MLD. The following embodiments are illustrated by taking the AP MLD as the mobile AP MLD, i.e., the AP MLD and the mobile AP MLD hereinafter are different names for the same device.

Specifically, the non-AP MLD and the mobile AP MLD have the NSTR link pair. That is, the mobile AP MLD and the non-AP MLD associated with the mobile AP MLD cannot receive data on one link of the NSTR link pair and synchronously transmit data on the other link of the NSTR link pair. Alternatively, the mobile AP MLD and the non-AP MLD associated with the mobile AP MLD cannot transmit data on one link of the NSTR link pair and synchronously receive data on the other link of the NSTR link pair.

The embodiments of the present disclosure only exemplify a case where the mobile AP MLD has one primary link and one non-primary link. Of course, the present disclosure may also be applied to a case where the mobile AP MLD has a plurality of primary links and/or a plurality of non-primary links.

In some embodiments, the non-AP MLD may include the NSTR link pair, and may include the STR link pair.

To be noted that the NSTR is generally for a pair of links, such as 5 GHz and 6 GHz. When the NSTR link pair is present in the mobile AP MLD, the mobile AP MLD cannot simultaneously transmit data on one link of the link pair and receive data on the other link of the link pair. When a 2.4 GHz and 6 GHz link pair is present in the mobile AP MLD, the mobile AP MLD may transmit data on one link of the link pair and simultaneously receive data on the other link of the link pair. That is, the mobile AP MLD cannot transmit data and receive data at the same time only when the mobile AP MLD is operating on the NSTR link pair. The NSTR is not a property of the device, but a property of the link.

Further, to be noted that, whether a multilink device can simultaneously transmit data and receive data on an NSTR link pair is substantially dependent on performance of the device. For a normal AP MLD device, even if the normal AP MLD device is operating on the NSTR link pair, as long as the AP MLD can solve the problem of in-device coexistence (IDC) interference, the normal AP MLD device may simultaneously transmit data and receive data on the NSTR link pair. However, the mobile AP MLD device does not have a capability of solving the problem of IDC interference, and therefore, the mobile AP MLD cannot simultaneously transmit data and receive data on the NSTR link pair.

In some embodiment, the network architecture used in the present embodiment may be as shown in FIG. 26, AP MLD devices have two affiliated APs, the AP1 and the AP2. The AP1 is associated, on the link 1 (the primary link), with the STA1 in the non-AP MLD. The AP2 is associated, on the link 2 (the non-primary link), with the STA2 in the non-AP MLD. The link 1 and the link 2 form one NSTR link pair.

Therefore, in the embodiments of the present disclosure, the non-AP MLD determines the primary link and the non-primary link based on the indication from the AP MLD while the non-AP MLD is establishing multilink connection with the AP MLD. In this way, a process of establishing the AP MLD-based multilink connection may be optimized.

Method embodiments of the present disclosure are described in detail above in conjunction with FIG. 7 to FIG. 34. Device embodiments of the present application are described in detail below in conjunction with FIG. 35 to FIG. 39. It should be understood that the device embodiments and the method embodiments correspond to each other, and similar descriptions can be made with reference to the method embodiments.

FIG. 35 is a schematic diagram of a wireless communication device 500 according to an embodiment of the present disclosure. As shown in FIG. 35, the wireless communication device 500 is the AP MLD and includes the following.

A communication unit 510 is configured to transmit the first information on the primary link to the first non-AP STA in the first non-AP MLD; or to transmit the first information on the primary link to the first non-AP STA.

The communication unit 510 is further configured to synchronously transmit the second information on the non-primary link to the second non-AP STA in the second non-AP MLD. The second information is configured to share the TXOP, which is obtained by the AP MLD on the non-primary link, to the second non-AP STA.

The first information is configured to indicate a length of the uplink PPDU transmitted on the primary link, and the second information is configured to indicate a length of the uplink PPDU synchronously transmitted on the non-primary link.

In some embodiments, the AP MLD includes at least one NSTR link pair in which receiving and transmission are not performed simultaneously, and one link pair of the at least one NSTR link pair includes the primary link and the non-primary link.

In some embodiments, the first information is carried via a frame, which is configured to reply to data transmission; and/or the second information is carried via a frame, which is transmitted after the TXOP is obtained.

In some embodiments, the frame, which is configured to reply to the data transmission, includes the control wrapper frame or the BA frame.

In some embodiments, the frame, which is transmitted after the TXOP is obtained, includes the trigger frame or the MU-RTS frame.

In some embodiments, the frame, which is configured to reply to data transmission, includes the control wrapper frame, and the frame, which is transmitted after the TXOP is obtained, includes the trigger frame or the MU-RTS frame.

The control wrapper frame includes the HT control field. The A-control sub-field in the HT control field includes the uplink synchronization indication sub-field and the uplink length sub-field.

The value of the uplink synchronization indication sub-field is configured to instruct the first non-AP STA to perform synchronous uplink transmission. The value of the uplink length sub-field is the same as the value of the uplink length sub-field carried in the trigger frame or in the MU-RTS frame.

Alternatively, the control wrapper frame includes the HT control field. The A-control sub-field in the HT control field includes the uplink data symbol sub-field. The length of the uplink PPDU indicated by the uplink data symbol sub-field is the same as the length of the uplink PPDU indicated by the uplink length sub-field carried in the trigger frame or in the MU-RTS frame.

In some embodiments, the control wrapper frame includes the carried frame field. The carried frame field includes the BA frame sub-field, the BA frame sub-field is configured to acknowledge the first PPDU previously transmitted by the first non-AP STA.

In some embodiments, the frame, which is configured to reply to the data transmission, includes the BA frame; and the frame, which is transmitted after the TXOP is obtained, includes the trigger frame or the MU-RTS frame.

The BA frame includes the BA control field. The reserved sub-field in the BA control field includes the uplink synchronization indication sub-field and the uplink data symbol sub-field. The value of the uplink synchronization indication sub-field is configured to instruct the first non-AP STA to perform synchronous uplink transmission. The length of the uplink PPDU indicated by the uplink data symbol sub-field is the same as the length of the uplink PPDU indicated by the uplink length sub-field carried in the trigger frame or in the MU-RTS frame.

In some embodiments, the backoff counter maintained by the first non-AP STA is firstly decremented to reach zero, and the backoff counter maintained by the AP device on the non-primary link of the AP MLD is decremented to reach zero subsequently.

In some embodiments, the backoff counter maintained by the AP device on the non-primary link in the AP MLD stops backing off while the AP device on the primary link in the AP MLD is transmitting the CTS frame. Further, after the AP device on the primary link in the AP MLD finishes transmitting the CTS frame, the backoff counter maintained by the AP device on the non-primary link in the AP MLD continues to be decremented.

In some embodiments, the backoff counter maintained by the AP device on the non-primary link of the AP MLD is firstly decremented to reach zero, and the backoff counter maintained by the first non-AP STA is decremented to reach zero subsequently.

In some embodiments, the AP device on the non-primary link of the AP MLD keeps the backoff counter, which is maintained by the AP device, at zero, after the backoff counter maintained by the AP device on the non-primary link of the AP MLD is decremented to reach zero, and before the AP MLD synchronously transmits the second information to the second non-AP STA on the non-primary link.

In some embodiments, when the backoff counter maintained by the first non-AP STA is decremented to reach zero, the first non-AP STA transmits uplink data on the obtained TXOP synchronously with other non-APs in the first non-AP MLD. Alternatively, the first non-AP STA transmits uplink data on the obtained TXOP.

In some embodiments, the first information is transmitted via the first frame, and the second information is transmitted via the second frame. The value of the uplink length sub-field carried in the first frame is the same as the value of the uplink length sub-field carried in the second frame.

In some embodiments, the first frame is the trigger frame or the MU-RTS frame, and/or, the second frame is the trigger frame or the MU-RTS frame.

In some embodiments, the backoff counter maintained by the AP device on the non-primary link in the AP MLD is decremented to reach zero firstly, and the backoff counter maintained by the AP device on the primary link in the AP MLD is decremented to reach zero subsequently.

In some embodiments, the AP device on the non-primary link in the AP MLD keeps the backoff counter, which is maintained by the AP device, at zero, after the backoff counter maintained by the AP device on the non-primary link in the AP MLD is decremented to reach zero and before the AP MLD synchronously transmits the second information to the second non-AP STA on the non-primary link in the AP MLD.

Alternatively, the AP device on the non-primary link in the AP MLD keeps the backoff counter, which is maintained by the AP device, at zero, after the backoff counter maintained by the AP device on the non-primary link in the AP MLD is decremented to reach zero and before the AP MLD transmits the MU-RTS frame on the non-primary link to the second non-AP STA.

In some embodiments, when the backoff counter maintained by the AP device on the primary link in the AP MLD is decremented to reach zero, the communication unit is further configured to perform synchronous downlink transmission on the primary link and on the non-primary link.

Alternatively, when the backoff counter maintained by the AP device on the primary link in the AP MLD is decremented to reach zero and the first non-AP STA and/or the second non-AP STA has uplink data that is to be transmitted urgently, the communication unit 510 is further configured to abandon the synchronous downlink transmission on both the primary link and the non-primary link.

In some embodiments, the communication unit 510 is configured to share the TXOP, which is obtained by the AP MLD on the non-primary link, to the second non-AP STA based on the request from the first non-AP STA.

In some embodiments, the first non-AP MLD determines, based on the indication from the AP MLD, the primary link and the non-primary link while the first non-AP MLD is establishing the multilink connection with the AP MLD; and/or the second non-AP MLD determines, based on the indication from the AP MLD, the primary link and the non-primary link while the second non-AP MLD is establishing multilink connection with the AP MLD.

In some embodiments, the communication unit may be a communication interface or a transceiver, or an input/output interface of a communication chip or a system-on-chip.

It should be understood that the wireless communication device 500 according to embodiments of the present disclosure may correspond to the AP MLD in the method embodiments of the present disclosure. The above and other operations and/or functions of various units in the wireless communication device 500 allow corresponding processes of the AP MLD in the method 200 shown in FIG. 7 to FIG. 24 to be achieved, and will not be repeated herein.

FIG. 36 is a schematic diagram of a wireless communication device 600 according to an embodiment of the present disclosure. As shown in FIG. 36, the wireless communication device 600 is the first non-AP STA device or the first non-AP STA in the first non-AP MLD. The wireless communication device 600 may include the following.

A communication unit 610 is configured to receive the first information transmitted by the AP MLD on the primary link.

The first information is configured to indicate the length of the uplink PPDU that is synchronously transmitted on the primary link.

In some embodiments, the AP MLD includes at least one NSTR link pair in which receiving and transmission are not performed simultaneously, one link pair of the at least one NSTR link pair includes the primary link and the non-primary link.

In some embodiments, the first information is carried via a frame, which is configured to reply to data transmission.

In some embodiments, the frame, which is configured to reply to the data transmission, includes the control wrapper frame or the BA frame.

In some embodiments, the frame, which is configured to reply to the data transmission, includes the control wrapper frame.

The control wrapper frame includes the HT control field. The A-control sub-field in the HT control field includes the uplink synchronization indication sub-field and the uplink length sub-field. The value of the uplink synchronization indication sub-field is configured to instruct the first non-AP STA to perform synchronous uplink transmission. The value of the uplink length sub-field is the same as the value of the uplink length sub-field carried in the trigger frame or in the MU-RTS frame, and the trigger frame or the MU-RTS frame carries the second information. The second information is configured to indicate the length of the uplink PPDU transmitted on the non-primary link.

Alternatively, the control wrapper frame includes the HT control field. The A-control sub-field in the HT control field includes the uplink data symbol sub-field. The length of the uplink PPDU indicated by the uplink data symbol sub-field is the same as the length of the uplink PPDU indicated by the uplink length sub-field carried in the trigger frame or in the MU-RTS frame, and the trigger frame or the MU-RTS frame carries the second information. The second information is configured to indicate the length of the uplink PPDU that is synchronously transmitted on the non-primary link.

In some embodiments, the control wrapper frame includes the carried frame field. The carried frame field includes the BA frame sub-field, the BA frame sub-field is configured to acknowledge the first PPDU previously transmitted by the first non-AP STA.

In some embodiments, the frame, which is configured to reply to the data transmission, includes the BA frame.

The BA frame includes the BA control field. The reserved sub-field in the BA control field includes the uplink synchronization indication sub-field and the uplink data symbol sub-field. The value of the uplink synchronization indication sub-field is configured to instruct the first non-AP STA to perform synchronous uplink transmission. The length of the uplink PPDU indicated by the uplink data symbol sub-field is the same as the length of the uplink PPDU indicated by the uplink length sub-field carried in the trigger frame or in the MU-RTS frame, and the trigger frame or the MU-RTS frame carries the second information. The second information is configured to indicate the length of the uplink PPDU that is synchronously transmitted on the non-primary link.

In some embodiments, the backoff counter maintained by the first non-AP STA is firstly decremented to reach zero, and the backoff counter maintained by the AP device on the non-primary link of the AP MLD is decremented to reach zero subsequently.

In some embodiments, the backoff counter maintained by the AP device on the non-primary link in the AP MLD stops backing off while the AP device on the primary link in the AP MLD is transmitting the CTS frame. Further, after the AP device on the primary link in the AP MLD finishes transmitting the CTS frame, the backoff counter maintained by the AP device on the non-primary link in the AP MLD continues to be decremented.

In some embodiments, the backoff counter maintained by the AP device on the non-primary link of the AP MLD is firstly decremented to reach zero, and the backoff counter maintained by the first non-AP STA is decremented to reach zero subsequently.

In some embodiments, when the backoff counter maintained by the first non-AP STA is decremented to reach zero, the communication unit 610 is configured to transmit uplink data on the obtained TXOP synchronously with other non-APs in the first non-AP MLD. Alternatively, the communication unit 610 is configured to transmit the uplink data on the obtained TXOP.

In some embodiments, the first information is transmitted via the first frame. The value of the uplink length sub-field carried in the first frame is the same as the value of the uplink length sub-field carried in the second frame. The second frame carries the second information. The second information is configured to indicate the length of the uplink PPDU that is synchronously transmitted on the non-primary link.

In some embodiments, the first frame is the trigger frame or the MU-RTS frame, and/or, the second frame is the trigger frame or the MU-RTS frame.

In some embodiments, the backoff counter maintained by the AP device on the non-primary link in the AP MLD is decremented to reach zero firstly, and the backoff counter maintained by the AP device on the primary link in the AP MLD is decremented to reach zero subsequently.

In some embodiments, the communication unit 610 is further configured to transmit the uplink data based on the first information.

In some embodiments, the first non-AP MLD determines, based on the indication from the AP MLD, the primary link and the non-primary link while the first non-AP MLD is establishing the multilink connection with the AP MLD.

In some embodiments, the communication unit may be a communication interface or a transceiver, or an input/output interface of a communication chip or a system-on-chip.

It should be understood that the wireless communication device 600 according to embodiments of the present disclosure may correspond to the first non-AP STA device or the first non-AP STA in the first non-AP MLD in the method embodiments of the present disclosure. The above and other operations and/or functions of various units in the wireless communication device 600 allow corresponding processes of the first non-AP STA device or the first non-AP STA in the first non-AP MLD in the method 200 shown in FIG. 7 to FIG. 24 to be achieved, and will not be repeated herein.

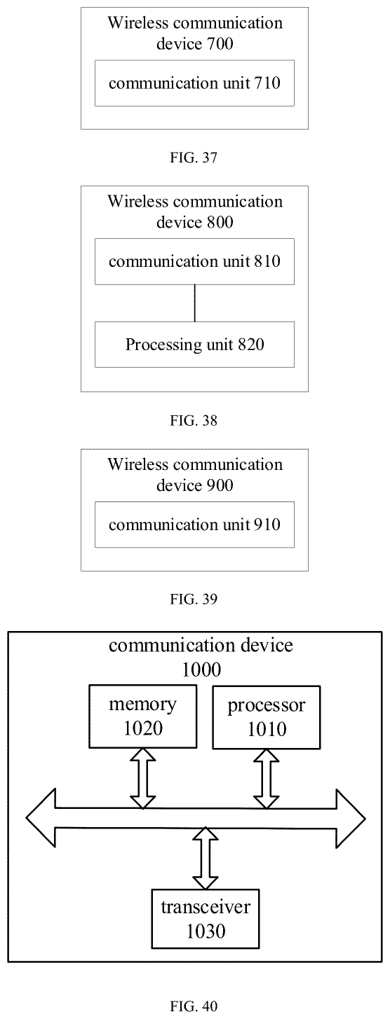

FIG. 37 is a schematic diagram of a wireless communication device 700 according to an embodiment of the present disclosure. As shown in FIG. 37, the wireless communication device 700 is the second non-AP STA in the second non-AP MLD and includes the following.

A communication unit 710 is configured to receive the second information transmitted by the AP MLD on the non-primary link.

The second information is configured to share the TXOP, which is obtained by the AP MLD on the non-primary link, to the second non-AP STA. The second information is configured to indicate the length of the uplink PPDU synchronously transmitted on the non-primary link.

In some embodiments, the AP MLD includes at least one NSTR link pair in which receiving and transmission are not performed simultaneously, and one link pair of the at least one NSTR link pair includes the primary link and the non-primary link.

In some embodiments, the second information is carried via a frame, which is transmitted after the TXOP is obtained.

In some embodiments, the frame, which is transmitted after the TXOP is obtained, includes the trigger frame or the MU-RTS frame.

In some embodiments, the first information is transmitted via the trigger frame or the MU-RTS frame.

In some embodiments, the backoff counter maintained by the first non-AP STA is firstly decremented to reach zero, and the backoff counter maintained by the AP device on the non-primary link of the AP MLD is decremented to reach zero subsequently.

In some embodiments, the backoff counter maintained by the AP device on the non-primary link in the AP MLD stops backing off while the AP device on the primary link in the AP MLD is transmitting the CTS frame. Further, after the AP device on the primary link in the AP MLD finishes transmitting the CTS frame, the backoff counter maintained by the AP device on the non-primary link in the AP MLD continues to be decremented.

In some embodiments, the backoff counter maintained by the AP device on the non-primary link of the AP MLD is firstly decremented to reach zero, and the backoff counter maintained by the first non-AP STA is decremented to reach zero subsequently.

In some embodiments, the AP device on the non-primary link of the AP MLD keeps the backoff counter, which is maintained by the AP device, at zero, after the backoff counter maintained by the AP device on the non-primary link of the AP MLD is decremented to reach zero, and before the AP MLD synchronously transmits the second information to the second non-AP STA on the non-primary link.

In some embodiments, the second information is transmitted via the second frame. The value of the uplink length sub-field carried in the second frame is the same as the value of the uplink length sub-field carried in the first frame. The first frame carries the first information that is configured to indicate the length of the uplink PPDU that is synchronously transmitted on the primary link.

In some embodiments, the first frame is the trigger frame or the MU-RTS frame, and/or, the second frame is the trigger frame or the MU-RTS frame.

In some embodiments, the backoff counter maintained by the AP device on the non-primary link in the AP MLD is decremented to reach zero firstly, and the backoff counter maintained by the AP device on the primary link in the AP MLD is decremented to reach zero subsequently.

In some embodiments, the AP device on the non-primary link in the AP MLD keeps the backoff counter, which is maintained by the AP device, at zero, after the backoff counter maintained by the AP device on the non-primary link in the AP MLD is decremented to reach zero and before the AP MLD synchronously transmits the second information to the second non-AP STA on the non-primary link in the AP MLD.

Alternatively, the AP device on the non-primary link in the AP MLD keeps the backoff counter, which is maintained by the AP device, at zero, after the backoff counter maintained by the AP device on the non-primary link in the AP MLD is decremented to reach zero and before the AP MLD transmits the MU-RTS frame on the non-primary link to the second non-AP STA.

In some embodiments, the communication unit 710 is configured to transmit the uplink data based on the second information.

In some embodiments, the second non-AP MLD determines, based on the indication from the AP MLD, the primary link and the non-primary link while the second non-AP MLD is establishing the multilink connection with the AP MLD.

In some embodiments, the communication unit may be a communication interface or a transceiver, or an input/output interface of a communication chip or a system-on-chip.

It should be understood that the wireless communication device 700 according to embodiments of the present disclosure may correspond to the second non-AP STA in the second non-AP MLD in the method embodiments of the present disclosure. The above and other operations and/or functions of various units in the wireless communication device 700 allow corresponding processes of the second non-AP STA in the second non-AP MLD in the method 200 shown in FIG. 7 to FIG. 24 to be achieved, and will not be repeated herein.

FIG. 38 is a schematic diagram of a wireless communication device 800 according to an embodiment of the present disclosure. As shown in FIG. 38, the wireless communication device 800 is the AP MLD and includes the following.

A communication unit 810 is configured to transmit the first information on the primary link to the first non-AP STA in the non-AP MLD and to synchronously transmit the second information on the non-primary link to the second non-AP STA in the non-AP MLD.

The second information is configured to share the TXOP, which is obtained by the AP MLD on the non-primary link, to the second non-AP STA. The first information is configured to indicate the length of the uplink PPDU that is transmitted on the primary link, the second information is configured to indicate the length of the uplink PPDU that is transmitted on the non-primary link, and the indicated PPDUs are transmitted synchronously.

In some embodiments, the AP MLD includes at least one NSTR link pair in which receiving and transmission are not performed simultaneously, and one link pair of the at least one NSTR link pair includes the primary link and the non-primary link.

In some embodiments, the communication unit 810 is configured to receive the first indication information, which is transmitted by the first non-AP STA in the non-AP MLD on the primary link. The first indication information is configured to instruct the AP MLD to assist the second non-AP STA in listening to the non-primary link.

In some embodiments, the wireless communication device 800 further includes a processing unit 820.

The processing unit 820 is configured to assist the second non-AP STA in listening to the non-primary link based on the first indication information.

In some embodiments, the backoff counter maintained by the first non-AP STA is firstly decremented to reach zero, and the backoff counter maintained by the AP device on the non-primary link of the AP MLD is decremented to reach zero subsequently. The AP device on the non-primary link in the AP MLD keeps the backoff counter, which is maintained by the AP device, at zero, after the backoff counter maintained by the AP device on the non-primary link in the AP MLD is decremented to reach zero and before the second information is transmitted on the non-primary link of the AP MLD.

In some embodiments, the backoff counter maintained by the AP device on the non-primary link in the AP MLD is firstly decremented to reach zero, and the backoff counter maintained by the first non-AP STA is decremented to reach zero subsequently. The AP device on the non-primary link of the AP MLD keeps the backoff counter, which is maintained by the AP device, at zero, after the backoff counter maintained by the AP device on the non-primary link of the AP MLD is decremented to reach zero, and before the second information is transmitted on the non-primary link of the AP MLD.

In some embodiments, the first indication information is included in the first frame, and the first frame is one of:

the control wrapper frame, the management frame, and the data frame.

In some embodiments, the backoff counter maintained by the AP device on the non-primary link in the AP MLD is firstly decremented to reach zero, and the backoff counter maintained by the first non-AP STA is decremented to reach zero subsequently. The AP device on the non-primary link of the AP MLD keeps the backoff counter, which is maintained by the AP device, at zero, after the backoff counter maintained by the AP device on the non-primary link of the AP MLD is decremented to reach zero, and before the second information is transmitted on the non-primary link of the AP MLD.

In some embodiments, the backoff counter maintained by the first non-AP STA is firstly decremented to reach zero, and the backoff counter maintained by the AP device on the non-primary link in the AP MLD is decremented to reach zero subsequently. The AP device on the non-primary link of the AP MLD keeps the backoff counter, which is maintained by the AP device, at zero, after the backoff counter maintained by the AP device on the non-primary link of the AP MLD is decremented to reach zero, and before the second information is transmitted on the non-primary link of the AP MLD.

In some embodiments, the backoff counter maintained by the AP device on the non-primary link in the AP MLD stops backing off while the AP device on the primary link in the AP MLD is transmitting the CTS frame. Further, after the AP device on the primary link in the AP MLD finishes transmitting the CTS frame, the backoff counter maintained by the AP device on the non-primary link in the AP MLD continues to be decremented.

In some embodiments, the backoff counter maintained by the AP device on the non-primary link of the AP MLD is firstly decremented to reach zero, and the backoff counter maintained by the AP device on the primary link of the AP MLD is decremented to reach zero subsequently. The AP device on the non-primary link of the AP MLD keeps the backoff counter, which is maintained by the AP device, at zero, after the backoff counter maintained by the AP device on the non-primary link of the AP MLD is decremented to reach zero, and before the second information is transmitted on the non-primary link of the AP MLD.

In some embodiments, the first information is included in the second frame, and the second frame is one of the following:

the trigger frame, the MU-RTS frame, and the BA frame.

In some embodiments, the second information is included in the third frame, and the third frame is one of:

the trigger frame and the MU-RTS frame.

In some embodiments, the non-AP MLD determines the primary link and the non-primary link based on instructions from the AP MLD while the non-AP MLD is establishing multilink connection with the AP MLD.

In some embodiments, the communication unit may be a communication interface or a transceiver, or an input/output interface of a communication chip or a system-on-chip.

It should be understood that the wireless communication device 800 according to embodiments of the present disclosure may correspond to the AP MLD in the method embodiments of the present disclosure. The above and other operations and/or functions of various units in the wireless communication device 800 allow corresponding processes of the AP MLD in the method 300 shown in FIG. 25 to FIG. 33 to be achieved, and will not be repeated herein.

FIG. 39 is a schematic diagram of a wireless communication device 900 according to an embodiment of the present disclosure. The wireless communication device 900 is the non-AP MLD and includes the following.

A communication unit 910 is configured to receive the first information, which is transmitted on the primary link by the AP MLD, through the first non-AP STA in the non-AP MLD and to receive the second information, which is synchronously transmitted on the non-primary link by the AP MLD, through the second non-AP STA in the non-AP MLD.

The second information is configured to share the TXOP, which is obtained by the AP MLD on the non-primary link, to the second non-AP STA. The first information is configured to indicate the length of the uplink PPDU that is transmitted on the primary link, the second information is configured to indicate the length of the uplink PPDU that is transmitted on the non-primary link, and the indicated PPDUs are transmitted synchronously.

In some embodiments, the AP MLD includes at least one NSTR link pair in which receiving and transmission are not performed simultaneously, and one link pair of the at least one NSTR link pair includes the primary link and the non-primary link.

In some embodiments, the communication unit 910 is configured to transmit the first indication information through the first non-AP STA in the non-AP MLD on the primary link. The first indication information is configured to instruct the AP MLD to assist the second non-AP STA in listening to the non-primary link.

In some embodiments, the backoff counter maintained by the first non-AP STA is firstly decremented to reach zero, and the backoff counter maintained by the AP device on the non-primary link of the AP MLD is decremented to reach zero subsequently. The AP device on the non-primary link in the AP MLD keeps the backoff counter, which is maintained by the AP device, at zero, after the backoff counter maintained by the AP device on the non-primary link in the AP MLD is decremented to reach zero and before the second information is transmitted on the non-primary link of the AP MLD.

In some embodiments, the backoff counter maintained by the AP device on the non-primary link in the AP MLD is firstly decremented to reach zero, and the backoff counter maintained by the first non-AP STA is decremented to reach zero subsequently. The AP device on the non-primary link of the AP MLD keeps the backoff counter, which is maintained by the AP device, at zero, after the backoff counter maintained by the AP device on the non-primary link of the AP MLD is decremented to reach zero, and before the second information is transmitted on the non-primary link of the AP MLD.

In some embodiments, the first indication information is included in the first frame, and the first frame is one of:

the control wrapper frame, the management frame, and the data frame.

In some embodiments, the backoff counter maintained by the AP device on the non-primary link in the AP MLD is firstly decremented to reach zero, and the backoff counter maintained by the first non-AP STA is decremented to reach zero subsequently. The AP device on the non-primary link of the AP MLD keeps the backoff counter, which is maintained by the AP device, at zero, after the backoff counter maintained by the AP device on the non-primary link of the AP MLD is decremented to reach zero, and before the second information is transmitted on the non-primary link of the AP MLD.

In some embodiments, the backoff counter maintained by the first non-AP STA is firstly decremented to reach zero, and the backoff counter maintained by the AP device on the non-primary link in the AP MLD is decremented to reach zero subsequently. The AP device on the non-primary link of the AP MLD keeps the backoff counter, which is maintained by the AP device, at zero, after the backoff counter maintained by the AP device on the non-primary link of the AP MLD is decremented to reach zero, and before the second information is transmitted on the non-primary link of the AP MLD.

In some embodiments, the backoff counter maintained by the AP device on the non-primary link in the AP MLD stops backing off while the AP device on the primary link in the AP MLD is transmitting the CTS frame. Further, after the AP device on the primary link in the AP MLD finishes transmitting the CTS frame, the backoff counter maintained by the AP device on the non-primary link in the AP MLD continues to be decremented.

In some embodiments, the backoff counter maintained by the AP device on the non-primary link of the AP MLD is firstly decremented to reach zero, and the backoff counter maintained by the AP device on the primary link of the AP MLD is decremented to reach zero subsequently. The AP device on the non-primary link of the AP MLD keeps the backoff counter, which is maintained by the AP device, at zero, after the backoff counter maintained by the AP device on the non-primary link of the AP MLD is decremented to reach zero, and before the second information is transmitted on the non-primary link of the AP MLD.

In some embodiments, the first information is included in the second frame, and the second frame is one of the following:

the trigger frame, the MU-RTS frame, and the BA frame.

In some embodiments, the second information is included in the third frame, and the third frame is one of:

the trigger frame and the MU-RTS frame.

In some embodiments, the non-AP MLD determines the primary link and the non-primary link based on instructions from the AP MLD while the non-AP MLD is establishing multilink connection with the AP MLD.

In some embodiments, the communication unit may be a communication interface or a transceiver, or an input/output interface of a communication chip or a system-on-chip.

In some embodiments, the wireless communication device 800 further includes a processing unit 820.

The processing unit 820 is configured to assist the second non-AP STA in listening to the non-primary link based on the first indication information.

It should be understood that the wireless communication device 900 according to embodiments of the present disclosure may correspond to the non-AP MLD in the method embodiments of the present disclosure. The above and other operations and/or functions of various units in the wireless communication device 900 allow corresponding processes of the non-AP MLD in the method 300 shown in FIG. 25 to FIG. 33 to be achieved, and will not be repeated herein.

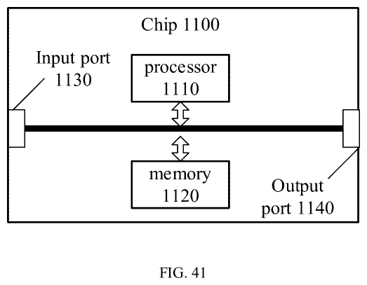

FIG. 40 is a schematic diagram of a communication device 1000 according to an embodiment of the present disclosure. The communication device 1000 as shown in FIG. 40 includes a processor 1010. The processor 1010 may invoke and run computer programs from a memory to perform the method in the embodiments of the present disclosure.

In some embodiments, as shown in FIG. 35, the communication device 1000 may further include a memory 1020. The processor 1010 may invoke and run computer programs from the memory 1020 to perform the method in the embodiment of the present disclosure.

The memory 1020 may be an element independent from the processor 1010 or may be integrated into the processor 1010.

In some embodiments, as shown in FIG. 35, the communication device 1000 may further include a transceiver 1030. The processor 1010 may control the transceiver 1030 to communicate with other devices. Specifically, the processor 1010 may control the transceiver 1030 to transmit information or data to other devices or to receive information or data sent from other devices.

The transceiver 1030 may include a transmitter and a receiver. The transceiver 1030 may further include an antenna, and the number of antennas may be one or more.

In some embodiments, the communication device 1000 may specifically be the AP MLD of the present disclosure. The communication device 1000 may implement the corresponding processes performed by the AP MLD in various methods of the present disclosure, which will not be repeated herein.

In some embodiments, the communication device 1000 may specifically be the first non-AP STA device or the first non-AP MLD in the embodiments. The communication device 1000 may implement the corresponding processes performed by the first non-AP STA device or the first non-AP MLD in the various method embodiments of the present disclosure, which are not repeated herein.

In some embodiments, the communication device 1000 may specifically be the second non-AP MLD in the embodiments of the present disclosure. The communication device 1000 may implement the corresponding processes performed by the second non-AP MLD in the various method embodiments of the present disclosure, which will not be repeated herein.

In some embodiments, the communication device 1000 may specifically be the non-AP MLD in the embodiments of the present disclosure. The communication device 1000 may implement the corresponding processes performed by the non-AP MLD in various method embodiments of the present disclosure, which will not be repeated herein.

FIG. 41 is a schematic diagram of a chip according to an embodiment of the present disclosure. The chip 1100 shown in FIG. 41 includes a processor 1110. The processor 1110 may invoke and run computer programs from a memory to implement the method in the embodiments of the present disclosure.

In some embodiments, as shown in FIG. 41, the chip 1100 may further include a memory 1120. The processor 1110 may invoke and run computer programs from the memory 1120 to implement the method in the embodiments of the present disclosure.

The memory 1120 may be an element independent from the processor 1110 or may be integrated into the processor 1110.

In some embodiments, the chip 1100 may further include an input interface 1130. The processor 1110 may control the input interface 1130 to communicate with other devices or chips, specifically, to obtain information or data sent by other devices or chips.

In some embodiments, the chip 1100 may further include an output interface 1140. The processor 1110 may control the output interface 1140 to communicate with other devices or chips, specifically, to output information or data to other devices or chips.

In some embodiments, the chip may be applied to the AP MLD in the embodiments of the present disclosure. The chip may implement the corresponding processes performed by the AP MLD in the various method embodiments of the present disclosure, which will not be repeated herein.

In some embodiments, the chip may be applied to the first non-AP STA device or the first non-AP MLD in the embodiments of the present disclosure. The chip may implement the corresponding processes performed by the first non-AP STA device or the first non-AP MLD in the various method embodiments of the present disclosure, which will not be repeated herein.

In some embodiments, the chip may be applied to the second non-AP MLD in the embodiments of the present disclosure. The chip may implement the corresponding processes performed by the second non-AP MLD in the various method embodiments of the present disclosure, which will not be repeated herein.

In some embodiments, the chip may be applied to the non-AP MLD in the embodiments of the present disclosure. The chip may implement the corresponding processes performed by the non-AP MLD in the various method embodiments of the present disclosure, which will not be repeated herein.

It should be understood that the chip in the embodiments of the present disclosure may be referred to as a system-on-chip, a system chip, a chip system, or a chip-on-system, and so on.

It should be understood that the processor of the embodiments of the present disclosure may be an integrated circuit chip having signal processing capabilities. In practice, operations of the above method embodiments may be performed by integrated logic circuits of hardware in the processor or by instructions in the form of software. The above-described processor may be a general-purpose processor, a digital signal processor (DSP), an application specific integrated circuit (ASIC), a field programmable gate array (FPGA), or other programmable logic devices, discrete gate or transistor logic devices, and discrete hardware components. Various methods, operations, and logic block diagrams in the embodiments of the present disclosure may be performed. The general purpose processor may be a microprocessor or any conventional processor. The operations of the methods disclosed in the embodiments of the present disclosure may be directly implemented by a hardware decoding processor or performed by a combination of hardware and software modules in the decoding processor. The software module may be configured in a random memory, a flash memory, a read-only memory, a programmable read-only memory or an electrically erasable programmable memory, a register, and other storage media that are well known in the art. The storage medium is configured in the memory. The processor reads the information in the memory and operates cooperatively with other hardware to perform the operations in the above methods.

It should be understood that the memory in the embodiments of the present disclosure may be volatile or non-volatile or may include both volatile memories and non-volatile memories. The non-volatile memory may be a read-only memory (ROM), a programmable ROM (PROM), an erasable programmable read-only memory (EPROM), an electrically erasable programmable read-only memory (EEPROM), or a flash memory. The volatile memory may be a random access memory (RAM), which is used as an external cache. By way of illustration, but not limitation, various forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM) and a direct rambus random access memory (DR RAM). To be noted that the memories of the systems and methods described herein are intended to include, but are not limited to, these and any other suitable types of memories.

It should be understood that the above memories are exemplary but not limiting descriptions. For example, the memories in the embodiments of the present disclosure may alternatively be a static random access memory (SRAM), a dynamic random access memory (DRAM), a synchronous DRAM (SDRAM), a double data rate SDRAM (DDR SDRAM), an enhanced SDRAM (ESDRAM), a synch link DRAM (SLDRAM), and a direct rambus random access memory (DR DRAM), and so on. That is, the memories in the embodiments of the present disclosure are intended to include, but are not limited to, these and any other suitable types of memories.

Embodiments of the present disclosure further provide a computer-readable storage medium configured to store computer programs.

In some embodiments, the computer-readable storage medium may be applied to the AP MLD in embodiments of the present disclosure. The computer programs cause the computer to perform the corresponding processes performed by the AP MLD in the various method embodiments of the present disclosure, which are not described herein.

In some embodiments, the computer-readable storage medium may be applied to the first non-AP STA device or the first non-AP MLD in the embodiments of the present disclosure. The computer programs cause the computer to perform the corresponding processes performed by the first non-AP STA device or the first non-AP MLD in the various method embodiments of the present disclosure, which are not repeated herein.

In some embodiments, the computer-readable storage medium may be applied to the second non-AP MLD in the embodiments of the present disclosure. The computer programs cause the computer to perform the corresponding processes performed by the second non-AP MLD in the various method embodiments of the present disclosure, which are not described herein.

In some embodiments, the computer-readable storage medium may be applied to the non-AP MLD in the embodiments of the present disclosure. The computer programs cause the computer to perform the corresponding processes performed by the non-AP MLD in the various method embodiments of the present disclosure, which are not repeated herein.

Embodiments of the present disclosure further provide a computer program product including computer program instructions.

In some embodiments, the computer program product may be applied to the AP MLD in the embodiments of the present disclosure. The computer program instructions cause the computer to perform the corresponding processes performed by the AP MLD in the various method embodiments of the present disclosure, which are not described herein.

In some embodiments, the computer program product may be applied to the first non-AP STA device or the first non-AP MLD in the embodiments of the present disclosure. The computer program instructions cause the computer to perform the corresponding processes performed by the first non-AP STA device or the first non-AP MLD in the various method embodiments of the present disclosure, which are not described herein.

In some embodiments, the computer program product may be applied to the second non-AP MLD in the embodiments of the present disclosure. The computer program instructions cause the computer to perform the corresponding processes performed by the second non-AP MLD in the various method embodiments of the present disclosure, which are not described herein.

In some embodiments, the computer program product may be applied to the non-AP MLD in the embodiments of the present disclosure. The computer program instructions cause the computer to perform the corresponding processes performed by the non-AP MLD in the various method embodiments of the present disclosure, which will not be repeated herein.

Embodiments of the present disclosure further provide a computer program.

In some embodiments, the computer program may be applied to the AP MLD in the embodiments of the present disclosure. When the computer program is run on the computer, the computer is caused to execute the corresponding processes performed by the AP MLD in the various method embodiments of the present disclosure, which are not described herein.

In some embodiments, the computer program may be applied to the first non-AP STA device or the first non-AP MLD in the embodiments of the present disclosure. When the computer program is run on the computer, the computer is caused to perform the corresponding processes performed by the first non-AP STA device or the first non-AP MLD in the method embodiments of the present disclosure, which are not repeated herein.

In some embodiments, the computer program may be applied to the second non-AP MLD in the embodiments of the present disclosure. When the computer program is run on the computer, the computer is caused to execute the corresponding processes performed by the second non-AP MLD in the method embodiments of the present disclosure, which will not be repeated herein.

In some embodiments, the computer program may be applied to the non-AP MLD in embodiments of the present disclosure. When the computer program is run on the computer, the computer is caused to perform the corresponding processes performed by the non-AP MLD in the method embodiments of the present disclosure, which are not repeated herein.

Any ordinary skilled person in the art may realize that the units and algorithmic steps of the various examples described in conjunction with the embodiments may be implemented in electronic hardware or in a combination of computer software and electronic hardware. Whether these functions are performed in hardware or software depends on the particular application and design constraints of the technical solution. The ordinary skilled person in the art may use various methods to implement the described functions for each particular application, and such implementations shall not be considered as being outside the scope of the present disclosure.

Any ordinary skilled person in the art may clearly understand that the specific operating processes of the system, the device, and the unit described above may be referred to the corresponding processes in the above method embodiments and will not be repeated herein.

In the various embodiments provided in the present disclosure, it is understood that the system, the device, and the method disclosed in the above may be implemented in other ways. For example, the device embodiments described above are merely schematic. For example, the units are divided based on logical functions only. In practice, the units may be divided in other ways. For example, multiple units or components may be combined or may be integrated into another system, or some features may be omitted or not implemented. Further, the mutual coupling or direct coupling or communicative connection may be indirect coupling or communicative connection through an interface, a device, or a unit, and the connection may be electrical connection, mechanical connection, and so on.

The units, which are illustrated as separated components, may or may not be physically separated. Components, which are displayed as units, may or may not be physical components. That is, the components may be located in one place or distributed to a plurality of network units. Some or all of these components may be selected to achieve the purpose of the embodiments of the present disclosure.

In addition, the functional units in various embodiments of the present disclosure may be integrated in a single processing unit, or each unit may be physically present separately from each other, or two or more units may be integrated in a single unit.

When the functions are implemented in the form of a software functional unit and sold or used as a stand-alone product, the functions may be stored in a computer-readable storage medium. Based on this understanding, the essence of the technical solution of the present disclosure, or a part of the technical solution contributing to related art, or a part of the technical solution, may be embodied in the form of a software product. The computer software product is stored in a storage medium and includes a number of instructions to cause a computer device (which may be a personal computer, a server, or a network device, and so on) to perform all or part of the operations of the method described in various embodiments of the present disclosure. The aforementioned storage medium includes a USB flash drive, a portable hard drive, a read-only memory (ROM), a random access memory (RAM), a magnetic disc or an optical disc, and other media that can store program codes.

The foregoing describes only specific embodiments of the present disclosure, but the scope of the present disclosure is not limited thereto. Any ordinary skilled person in the art may easily perform variations or substitutions within the scope disclosed in the present disclosure. All variations or substitutions shall be covered by the scope of the present disclosure. Therefore, the scope of the present disclosure may be subject to the scope of the claims.

What is claimed is:

1. A wireless communication method, comprising:
transmitting, by an access point (AP) multilink device (MLD), a first information on a primary link to a first non-access point station (non-AP STA) in a first non-AP MLD; or transmitting, by the AP MLD, the first information on the primary link to the first non-AP STA;
synchronously transmitting, by the AP MLD, a second information on a non-primary link to a second non-AP STA in a second non-AP MLD, wherein the second information is configured to share a transmission opportunity (TXOP), which is obtained by the AP MLD on the non-primary link, to the second non-AP STA;
wherein the first information is configured to indicate a length of an uplink physical layer protocol data unit (PPDU) transmitted on the primary link, the second information is configured to indicate a length of an uplink PPDU transmitted on the non-primary link, and the uplink PPDU on the primary link and the PPDU on the non-primary link are transmitted synchronously.

2. The wireless communication method according to claim 1, wherein, the AP MLD comprises at least one NSTR link pair in which receiving and transmission are not performed simultaneously, and one link pair of the at least one NSTR link pair comprises the primary link and the non-primary link.

3. The wireless communication method according to claim 1, wherein, the first information is carried via a frame, which is configured to reply to data transmission; and/or the second information is carried via a frame, which is transmitted after the TXOP is obtained.

4. The wireless communication method according to claim 3, wherein, the frame, which is configured to reply to the data transmission, comprises a control wrapper frame or a block acknowledgement (BA) frame.

5. The wireless communication method according to claim 3, wherein, the frame, which is transmitted after the TXOP is obtained, comprises a trigger frame or a multiple users request-to-send (MU-RTS) frame.

6. The wireless communication method according to claim 3, wherein, the frame, which is configured to reply to data transmission, comprises the control wrapper frame; and the frame, which is transmitted after the TXOP is obtained, comprises the trigger frame or the MU-RTS frame; wherein,
the control wrapper frame comprises a high throughput (HT) control field, an aggregation control (A-control) sub-field in the HT control field comprises an uplink synchronization indication sub-field and an uplink length sub-field; wherein a value of the uplink synchronization indication sub-field is configured to instruct the first non-AP STA to perform synchronous uplink transmission, a value of the uplink length sub-field is the same as a value of the uplink length sub-field carried in the trigger frame or in the MU-RTS frame; or
the control wrapper frame comprises the HT control field, the A-control sub-field in the HT control field comprises the uplink data symbol sub-field, wherein the length of the uplink PPDU indicated by the uplink data symbol sub-field is the same as the length of the uplink PPDU indicated by the uplink length sub-field carried in the trigger frame or in the MU-RTS frame.

7. The wireless communication method according to claim 6, wherein the control wrapper frame comprises a carried frame field, the carried frame field comprises a BA frame sub-field, the BA frame sub-field is configured to acknowledge a first PPDU previously transmitted by the first non-AP STA.

8. The wireless communication method according to claim 3, wherein the frame, which is configured to reply to the data transmission, comprises the BA frame; and the frame, which is transmitted after the TXOP is obtained, comprises the trigger frame or the MU-RTS frame;
wherein, the BA frame comprises a BA control field, a reserved sub-field in the BA control field comprises an uplink synchronization indication sub-field and an uplink data symbol sub-field; a value of the uplink synchronization indication sub-field is configured to instruct the first non-AP STA to perform synchronous uplink transmission, the length of the uplink PPDU indicated by the uplink data symbol sub-field is the same as the length of the uplink PPDU indicated by the uplink length sub-field carried in the trigger frame or in the MU-RTS frame.

9. The wireless communication method according to claim 3, wherein, a backoff counter maintained by the first non-AP STA is firstly decremented to reach zero, and a backoff counter maintained by the AP device on the non-primary link of the AP MLD is decremented to reach zero subsequently.

10. The wireless communication method according to claim 9, wherein, the backoff counter maintained by the AP device on the non-primary link in the AP MLD stops backing off while an AP device on the primary link in the AP MLD is transmitting a control-to-send (CTS) frame; and
after the AP device on the primary link in the AP MLD finishes transmitting the CTS frame, the backoff counter maintained by the AP device on the non-primary link in the AP MLD continues to be decremented.

11. The wireless communication method according to claim 3, wherein a backoff counter maintained by the AP device on the non-primary link of the AP MLD is firstly decremented to reach zero, and a backoff counter maintained by the first non-AP STA is decremented to reach zero subsequently.

12. The wireless communication method according to claim 9, wherein the AP device on the non-primary link of the AP MLD keeps the backoff counter, which is maintained by the AP device, at zero, after the backoff counter maintained by the AP device on the non-primary link of the AP MLD is decremented to reach zero and before the AP MLD synchronously transmits the second information to the second non-AP STA on the non-primary link.

13. The wireless communication method according to claim 9, wherein in response to the backoff counter maintained by the first non-AP STA being decremented to reach zero,
the first non-AP STA transmits uplink data on the obtained TXOP synchronously with other non-APs in the first non-AP MLD; or
the first non-AP STA transmits the uplink data on the obtained TXOP.

14. The wireless communication method according to claim 1, wherein, the first information is transmitted via a first frame, the second information is transmitted via a second frame; a value of an uplink length sub-field carried in the first frame is the same as a value of an uplink length sub-field carried in the second frame.

15. The wireless communication method according to claim 14, wherein, a backoff counter maintained by the AP device on the non-primary link in the AP MLD is decremented to reach zero firstly, and a backoff counter maintained by the AP device on the primary link in the AP MLD is decremented to reach zero subsequently.

16. The wireless communication method according to claim 15, wherein,
the AP device on the non-primary link in the AP MLD keeps the backoff counter, which is maintained by the AP device, at zero, after the backoff counter maintained by the AP device on the non-primary link in the AP MLD is decremented to reach zero and before the AP MLD synchronously transmits the second information to the second non-AP STA on the non-primary link in the AP MLD; or
the AP device on the non-primary link in the AP MLD keeps the backoff counter, which is maintained by the AP device, at zero, after the backoff counter maintained by the AP device on the non-primary link in the AP MLD is decremented to reach zero and before the AP MLD transmits the MU-RTS frame on the non-primary link to the second non-AP STA.

17. The wireless communication method according to claim 15, further comprising:
performing, by the AP MLD, synchronous downlink transmission on the primary link and on the non-primary link, in response to the backoff counter maintained by the AP device on the primary link in the AP MLD being decremented to reach zero; or
abandoning, by the AP MLD, the synchronous downlink transmission on both the primary link and the non-primary link, in response to: the backoff counter maintained by the AP device on the primary link in the AP MLD being decremented to reach zero, and the first non-AP STA and/or the second non-AP STA having uplink data that is to be transmitted urgently.

18. A wireless communication method, comprising:
receiving, by a first non-access point station (non-AP STA) in a non-access point multilink device (non-AP MLD), a first information which is transmitted by an access point multilink device (AP MLD) on a primary link; or receiving, by the first non-AP STA device, the first information transmitted by an access point multilink device (AP MLD) on the primary link;
wherein, the first information is configured to indicate a length of an uplink physical layer protocol data unit (PPDU) that is synchronously transmitted on the primary link.

19. The wireless communication method according to claim 18, wherein, the AP MLD comprises at least one NSTR link pair in which receiving and transmission are not performed simultaneously, one link pair of the at least one NSTR link pair comprises the primary link and a non-primary link.

20. A wireless communication device, being an access point (AP) multilink device (MLD) and comprising:
a communication unit, configured to transmit a first information on a primary link to a first non-access point station (non-AP STA) in a first non-AP MLD; or to transmit the first information on the primary link to the first non-AP STA;
wherein the communication unit is further configured to synchronously transmit a second information on a non-primary link to a second non-AP STA in a second non-AP MLD; the second information is configured to share a transmission opportunity (TXOP), which is obtained by the AP MLD on the non-primary link, to the second non-AP STA;
the first information is configured to indicate a length of an uplink physical layer protocol data unit (PPDU) transmitted on the primary link, the second information is configured to indicate a length of an uplink PPDU transmitted on the non-primary link, and the uplink PPDU on the primary link and the PPDU on the non-primary link are transmitted synchronously.
